(19) United States
(12) Patent Application Publication
(10) Pub. No.: US 2022/0068157 A1
(43) Pub. Date: Mar. 3, 2022

(54) Planner Systems and Related Methods

(71) Applicant: Driven Deep LLC, Sandy, UT (US)

(72) Inventor: Paul Moore, Sandy, UT (US)

(73) Assignee: Driven Deep LLC, Sandy, UT (US)

(21) Appl. No.: 17/445,944

(22) Filed: Aug. 25, 2021

Related U.S. Application Data
(60) Provisional application No. 62/706,569, filed on Aug. 25, 2020.

(51) Int. Cl. G09B 19/00; B42D 1/00

(52) U.S. Cl. CPC G09B 19/00; B42D 1/009

(57) ABSTRACT

A planner system includes a planner cover, one or more couplers, and a plurality of booklets removably coupled with the planner cover using the one or more couplers. The planner cover is sized to substantially cover the plurality of booklets in a closed configuration. The plurality of booklets includes: one or more routine tracker pages configured for receiving and tracking a plurality of daily tasks related to a routine; and one or more happiness planner pages configured for receiving and tracking a plurality of daily tasks related to improving happiness.

### CROSS REFERENCE TO RELATED APPLICATIONS

This document claims the benefit of the filing date of U.S. Provisional Patent Application No. 62/706,569, entitled “Planner Systems and Related Methods,” naming as first inventor Paul Moore, which was filed on Aug. 25, 2020, the disclosure of which is hereby incorporated entirely herein by reference.

### BACKGROUND

### 1. Technical Field

Aspects of this document relate generally to planners, such as daily planners, weekly planners, monthly planners, and so forth.

### 2. Background Art

A variety of written/print and online planners exist in the art. Such planners often include fields broken down by day and/or time for a user to indicate, for example, appointments and other scheduled items. Some planners include fields or space for the user to include notes, or blank pages or blank text fields for the user to input whatever comment they want. Some planners include calendars such as for a week or a month. Planners are generally used for organizing a user's time, schedule, or the like.

### SUMMARY

Implementations of planner systems may include: a planner cover; and a plurality of pages coupled with the planner cover, the plurality of pages including: one or more routine tracker pages configured for receiving and tracking a plurality of tasks related to a routine; and one or more happiness planner pages configured for receiving and tracking a plurality of tasks related to improving happiness.

Implementations of planner systems may include: a planner cover; one or more couplers; and a plurality of booklets removably coupled with the planner cover using the one or more couplers; wherein the planner cover is sized to substantially cover the plurality of booklets in a closed configuration; wherein the plurality of booklets includes: one or more routine tracker pages configured for receiving and tracking a plurality of daily tasks related to a routine; and one or more happiness planner pages configured for receiving and tracking a plurality of daily tasks related to improving happiness.

Implementations of planner systems may include one or more or all of the following:

The one or more routine tracker pages may include a time field for each task related to the routine to indicate a time at which it will be carried out.

The one or more routine tracker pages may include a tally section to indicate a number of times per week that a specific task related to the routine was accomplished.

The one or more routine tracker pages may include a tally section to indicate a number of tasks related to the routine that were accomplished in a day.

The one or more routine tracker pages may include a weekly tally section to indicate a number of tasks related to the routine that were accomplished in a week.

The one or more happiness planner pages may include a first section configured for receiving and tracking a spiritual task, a second section configured for receiving and tracking a physical task, a third section configured for receiving and tracking an intellectual task, a fourth section for receiving and tracking an emotional task, and a fifth section for receiving and tracking a social task.

The one or more happiness planner pages may include a plurality of example spiritual tasks, a plurality of example physical tasks, a plurality of example intellectual tasks, a plurality of example emotional tasks, and a plurality of example social tasks.

The one or more happiness planner pages may include an affirmation section for receiving one or more user-input affirmations.

The one or more happiness planner pages may include a gratitude section for a user to input one or more things the user is grateful for.

The one or more happiness planner pages may include a daily happiness rating configured to receive a daily user-input happiness level on a scale.

The one or more happiness planner pages may include a tally section to indicate a number of times per week that a specific task related to improving happiness was accomplished.

The one or more routine tracker pages may include a tally section to indicate a number of tasks related to improving happiness that were accomplished in a day.

The one or more routine tracker pages may include a weekly tally section to indicate a number of tasks related to improving happiness that were accomplished in a week.

The one or more happiness planner pages may include a weekly happiness rating configured to receive a weekly user-input happiness level on a scale.

The one or more happiness planner pages may include a section for receiving an indication of one or more things a user will continue doing to increase happiness.

The one or more happiness planner pages may include a section for receiving an indication of one or more things a user will stop doing in order to increase happiness.

The one or more happiness planner pages may include a section for receiving an indication of one or more things a user will start doing to increase happiness.

Implementations of planner systems may include: a planner cover; a routine tracker booklet coupled within the planner cover and configured for receiving and tracking a plurality of daily tasks related to a routine (routine tasks); and a happiness planner booklet coupled within the cover and configured for receiving and tracking a plurality of daily tasks related to improving happiness (happiness tasks); wherein the routine tracker booklet includes a first tally section to indicate a number of times per week that a specific routine task was accomplished, a second tally section to indicate a number of routine tasks that were accomplished in a day, and a weekly tally section to indicate a number of routine tasks that were accomplished in a week; and wherein the happiness planner booklet includes a first tally section to indicate a number of times per week that a specific happiness task was accomplished, a second tally section to indicate a number of happiness tasks that were accomplished in a day, and a weekly tally section to indicate a number of happiness tasks that were accomplished in a week.

Implementations of planner systems may include one or more or all of the following:

The happiness planner booklet may include a first section configured for receiving and tracking a spiritual task, a second section configured for receiving and tracking a physical task, a third section configured for receiving and tracking an intellectual task, a fourth section for receiving and tracking an emotional task, and a fifth section for receiving and tracking a social task.

General details of the above-described implementations, and other implementations, are given below in the DESCRIPTION, the DRAWINGS, the CLAIMS and the ABSTRACT.

### BRIEF DESCRIPTION OF THE DRAWINGS

Implementations will be discussed hereafter using reference to the included drawings, briefly described below, wherein like designations refer to like elements. The drawings are not necessarily drawn to scale.

FIG. 1 is a front perspective view of an implementation of a planner system;

FIG. 2 is a perspective view of a planner cover, in an open configuration, used in the planner system of FIG. 1;

FIG. 3 is a perspective view of the planner cover of FIG. 2 in a closed configuration;

FIG. 4 is a front perspective view of an implementation of a booklet of the planner system of FIG. 1;

FIG. 5 is a perspective view of two booklets of the planner system of FIG. 1, the booklets coupled together;

FIG. 6 shows an example page of one of the booklets of the FIG. 1 planner system or a user interface of a digital version of the planner system;

FIG. 7 shows an example page of one of the booklets of the FIG. 1 planner system or a user interface of a digital version of the planner system;

FIG. 8 shows an example page of one of the booklets of the FIG. 1 planner system or a user interface of a digital version of the planner system;

FIG. 9 shows an example page of one of the booklets of the FIG. 1 planner system or a user interface of a digital version of the planner system;

FIG. 10 shows a close-up view of logos/illustrations used in the FIG. 1 planner system;

FIG. 11 shows an example page of one of the booklets of the FIG. 1 planner system or a user interface of a digital version of the planner system;

FIG. 12 shows an example page of one of the booklets of the FIG. 1 planner system or a user interface of a digital version of the planner system;

FIG. 13 shows an example page of one of the booklets of the FIG. 1 planner system or a user interface of a digital version of the planner system;

FIG. 14 shows an example page of one of the booklets of the FIG. 1 planner system or a user interface of a digital version of the planner system;

FIG. 15 shows an example page of one of the booklets of the FIG. 1 planner system or a user interface of a digital version of the planner system;

FIG. 16 shows an example page of one of the booklets of the FIG. 1 planner system or a user interface of a digital version of the planner system;

FIG. 17 shows an example page of one of the booklets of the FIG. 1 planner system or a user interface of a digital version of the planner system;

FIG. 18 shows an example page of one of the booklets of the FIG. 1 planner system or a user interface of a digital version of the planner system;

FIG. 19 shows an example page of one of the booklets of the FIG. 1 planner system or a user interface of a digital version of the planner system;

FIG. 20 shows an example page of one of the booklets of the FIG. 1 planner system or a user interface of a digital version of the planner system;

FIG. 21 shows an example page of one of the booklets of the FIG. 1 planner system or a user interface of a digital version of the planner system;

FIG. 22 shows an example page of one of the booklets of the FIG. 1 planner system or a user interface of a digital version of the planner system;

FIG. 23 shows an example page of one of the booklets of the FIG. 1 planner system or a user interface of a digital version of the planner system;

FIG. 24 shows an example page of one of the booklets of the FIG. 1 planner system or a user interface of a digital version of the planner system;

FIG. 25 shows an example page of one of the booklets of the FIG. 1 planner system or a user interface of a digital version of the planner system;

FIG. 26 shows an example page of one of the booklets of the FIG. 1 planner system or a user interface of a digital version of the planner system;

FIG. 27 shows an example page of one of the booklets of the FIG. 1 planner system or a user interface of a digital version of the planner system;

FIG. 28 shows an example page of one of the booklets of the FIG. 1 planner system or a user interface of a digital version of the planner system;

FIG. 29 shows an example page of one of the booklets of the FIG. 1 planner system or a user interface of a digital version of the planner system;

FIG. 30 shows an example page of one of the booklets of the FIG. 1 planner system or a user interface of a digital version of the planner system;

FIG. 31 shows an example page of one of the booklets of the FIG. 1 planner system or a user interface of a digital version of the planner system;

FIG. 32 shows an example page of one of the booklets of the FIG. 1 planner system or a user interface of a digital version of the planner system;

FIG. 33 shows an example page of one of the booklets of the FIG. 1 planner system or a user interface of a digital version of the planner system;

FIG. 34 shows an example page of one of the booklets of the FIG. 1 planner system or a user interface of a digital version of the planner system;

FIG. 35 shows an example page of one of the booklets of the FIG. 1 planner system or a user interface of a digital version of the planner system;

FIG. 36 shows an example page of one of the booklets of the FIG. 1 planner system or a user interface of a digital version of the planner system;

FIG. 37 shows an example page of one of the booklets of the FIG. 1 planner system or a user interface of a digital version of the planner system;

FIG. 38 shows an example page of one of the booklets of the FIG. 1 planner system or a user interface of a digital version of the planner system;

FIG. 39 shows an example page of one of the booklets of the FIG. 1 planner system or a user interface of a digital version of the planner system;

FIG. 40 shows an example page of one of the booklets of the FIG. 1 planner system or a user interface of a digital version of the planner system;

FIG. 41 shows an example page of one of the booklets of the FIG. 1 planner system or a user interface of a digital version of the planner system;

FIG. 42 shows an example page of one of the booklets of the FIG. 1 planner system or a user interface of a digital version of the planner system;

FIG. 43 shows an example page of one of the booklets of the FIG. 1 planner system or a user interface of a digital version of the planner system;

FIG. 44 shows an example page of one of the booklets of the FIG. 1 planner system or a user interface of a digital version of the planner system;

FIG. 45 shows an example page of one of the booklets of the FIG. 1 planner system or a user interface of a digital version of the planner system; and

FIG. 46 shows a computing system used to implement a digital version of the planner system of FIG. 1.

### DESCRIPTION

Implementations/embodiments disclosed herein (including those not expressly discussed in detail) are not limited to the particular components or procedures described herein. Additional or alternative components, assembly procedures, and/or methods of use consistent with the intended planner systems and related methods may be utilized in any implementation. This may include any materials, components, sub-components, methods, sub-methods, steps, and so forth.

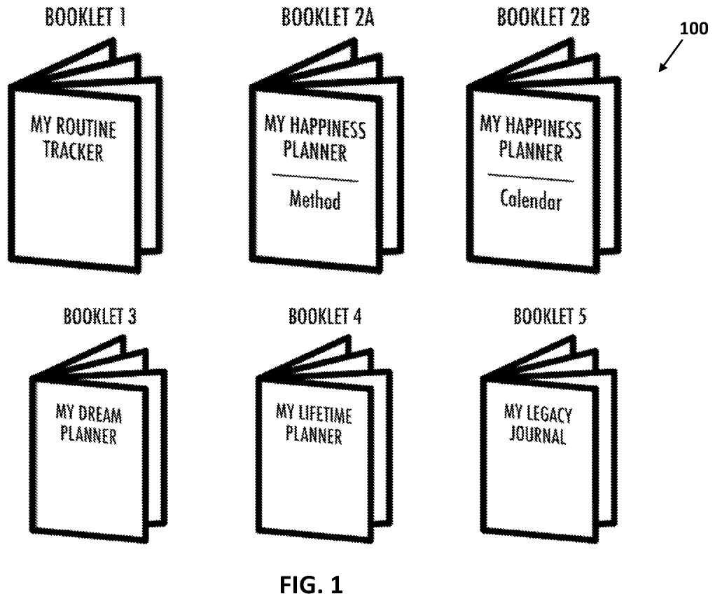

Referring to FIG. 1, an implementation of a planner system 100 is representatively illustrated. The planner system in implementations includes a number of planner booklets, including:
(1) a “My Routine Tracker” booklet (submitted as Appendix A to the specification); (2) a “My Happiness Planner Method” booklet (submitted as Appendix B to the specification);
(3) a “My Happiness Planner Calendar” booklet (submitted as Appendix C to the specification);
(4) a “My Dream Big Planner” booklet (also called “My Dream Planner” and/or a “My Dream Planner booklet” herein and in the drawings (submitted as Appendix D to the specification);
(5) a “My Lifetime Planner” booklet (submitted as Appendix E to the specification); and
(6) a “My Legacy Journal” booklet (submitted as Appendix F to the specification).

In implementations the booklets together may be called a “life balance ecosystem” inasmuch as they may be useful for helping users achieve life balance. In implementations the planner system is sold under the trademark DRIVEN DEEP so that the planner system may be called a DRIVEN DEEP life balance ecosystem, as in FIG. 1.

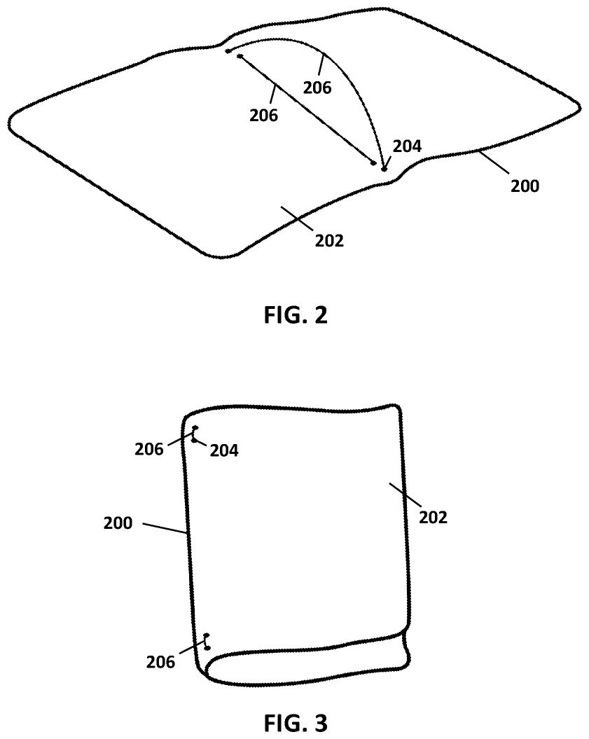

FIGS. 2 and 3 representatively illustrate an implementation of a planner cover (cover) 200 used in the planner system. FIG. 2 shows the planner cover in an open configuration and FIG. 3 shows the planner cover in a closed configuration. The planner cover in the shown implementation includes a cover material 202 formed into a rectangular (or somewhat rectangular) shape and having four through-holes 204 along a central spine area. A single elastic band is woven through the four through-holes in the configuration shown in FIGS. 2-3. A portion of the elastic band is shown having noticeable slack (in an arched configuration) but this is just for ease in viewing the other elements—in implementations the entire length of each portion of the elastic band will be taut (in a state of tension) so as to hold booklets tight within the planner cover. The cover material could be formed of a variety of material types such as, by non-limiting examples: leather, paper, cardstock, carboard, wood, metal, traditional book cover materials, a polymer, a cloth, and so forth. In implementations the cover material could have a shape other than a rectangular (or somewhat rectangular) shape, such as a triangular, semi-triangular, circular, somewhat circular, semi-circular, somewhat semi-circular, or any other regular or irregular shape. The booklets and pages that will be placed within the planner cover may have shapes and sizes generally matching the shape of the planner cover (i.e., so the cover fully covers the booklets and their pages in the closed configuration) or the booklets and pages may have shapes and sizes not matching the shape of the planner cover (and may either be fully covered by the planner cover, or may extend beyond the edges of the planner cover, in the closed configuration. Having the booklets/pages generally of a similar size and shape of the booklet (or somewhat smaller), however, allows the planner cover to more effectively protect the booklets in the closed configuration, by more fully covering them.

The planner cover is configured/designed to hold either one of the booklets of FIG. 1, two or more of the booklets, or all of the booklets. To hold a single booklet in place within the cover the booklet is opened to its center and one side of the booklet is slid or tucked underneath the elastic band so that the elastic band (one or two of the portions shown in FIG. 2) rests on the center page of the booklet at the inside/inner spine area of the booklet).

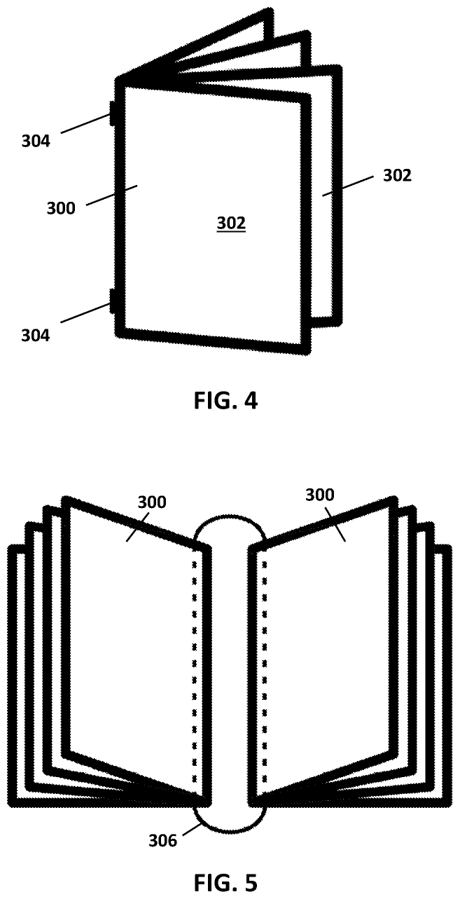

FIG. 4 shows an example configuration of the booklets of the planner system. Booklet 300 includes a number of pages 303 that are bound together using one or more couplers 304. By non-limiting example, several papers could be printed, stacked, folded to form a spine area, and stapled or saddle stitched to form the booklet. Other configurations are possible—pages could be coupled using an adhesive, or stitched using string or thread, or bound together using any other coupling mechanism.

As discussed above relative to FIG. 3, and elastic band may be coupled with the cover (this elastic band could be a single band threaded through the through-holes and then tied or melted or glued together at the ends to form a continuous loop). This elastic band 206 can be used to hold a single booklet, as described above. To add an additional booklet to the cover, an additional elastic band 306 can be used to couple two booklets together. Each booklet can be opened to its center, back to back, and the elastic band can be placed within the inner spine area of the center of each booklet. The booklets can then be coupled with the cover by sliding one of the entire booklets through/under the elastic band 206 (with one booklet on each side of the elastic band 206). This process can be repeated three times to have the cover house all six booklets shown in FIG. 1 (though to get the books in order the user would couple booklet 1 to booklet 5, booklet 2A to booklet 4, and booklet 2B to booklet 3, would tuck the combined booklets under the elastic band (one booklet on each side of the elastic band 206, in each case) in such a way that booklets 2A and 4 are stacked atop booklets 1 and 5, and in such a way that booklets 2B and 3 are stacked atop booklets 2A and 4). The elastic bands may be called couplers inasmuch as they are used to couple the booklets with the planner cover and/or the booklets with one another.

In implementations the elastic bands 206/306 are very tight, but they are shown somewhat loose (or with slack) in the drawings only so they are easier to see. The dotted line of FIG. 5 shows the location of the elastic band 306 within the booklets (but, again, in practice it may be very tight that it is flush against the inner spine of each book. Any of the elastic bands could be formed of polymer elastic materials, fabric-sheathed or thread-sheathed polymer elastic materials, or other elastic materials and could be formed as a continuous loop to begin with or could be a single strand that is formed into a continuous loop by tying, gluing, melting, or otherwise coupling the two ends together.

In implementations the planner system (or life balance ecosystem) gives individuals a framework to start to regain control of their lives. Many individuals don't get good sleep and don't nourish their bodies and minds the way they should be nourished. As a result many individuals are very unhappy and either try to fill voids in their life or numb negative feelings in unhealthy ways. Some negative feelings, however, don't have to be present and could be mitigated if people would nourish their minds and bodies in healthy ways. Additionally, many individuals don't look forward and set goals with the ends of their lives in mind. Accordingly, when the end of life is upon them they can have deep regret because they have wasted much time on activities that did not build them a better future. In implementations the planner system provides a solution to these issues, and to other issues. It provides a framework that is progressive (step by step), it teaches and helps users slowly and surely regain control of their habits and spend time in ways that will nourish their bodies, souls, minds, and so forth in the here and now (but also benefit their future 90-year-old selves). The different individual planners/booklets of the planner system are described below in more detail.

My Routine Tracker Booklet

The My Routine Tracker booklet helps users create better evening and morning routines so they can get better sleep. Doing these things will help an individual live longer, be healthier, and be more productive. The My Routine Tracker booklet is the anchor that prepares the user for the My Happiness Planner Method booklet. It anchors the user's day with good sleep so the user can more effectively implement 5 Dimensions of Happiness (discussed hereafter) as well as principles from the My Dream Planner, My Lifetime Planner and My Legacy Journal. As seen in Appendix A, the My Routine Tracker booklet in implementations has imagery of waves of the sea or ocean (and an anchor logo) on the outsides of the first and last pages to remind the user that this booklet is the “anchor” to prepare the user for the future booklets and methods/goals (the first page in Appendix A represents the first and last pages of the booklet as it folds in the center to enclose all other pages of the booklet).

A person's sleeping schedule and morning routine can be important pillars to providing consistency and stability to each new day. If a person gets out of the sleeping schedule and morning routine, it is easy for life to become imbalanced. Short-term interruptions to a sleeping schedule and morning routine may not be as disruptive, but if a sleeping schedule and morning routine are not maintained over the long term the person's life can become increasingly chaotic. Good sleep improves our immune systems, reduces rates of heart attacks, car crashes, road traffic accidents, and suicide rates, and improves our ability to maintain or not gain weight (by facilitating healthy levels of hormones related to hunger and lack of hunger). There are other ways in which good sleep affects our mental and physical health, happiness and longevity.

Some things that help a person to get a good night's rest are: (1) sticking to a sleep schedule—going to bed and waking up at the same time each day; (2) avoiding caffeine and other stimulants (the effects of caffeine can take up to 8 hours to fully wear off); (3) avoiding large meals and beverages late at night; (4) avoiding naps after 3 PM; (5) taking time to relax and unwind before bed; and (6) having a dark, cool and gadget-free bedroom.

Getting good sleep at night allows a person to operate better during the day. The My Routine Tracker booklet discusses various aspects related to good sleep and provides various quotes from, and citations to, sleep-related references. The booklet helps users to “anchor” themselves to an evening and morning routine/structure so that they get deeper and longer sleep. As users get more and better quality sleep, user's brains and bodies will be sharper, stronger and more rested during the day, helping to improve their productivity. Anchoring users to good sleep helps strengthen and protect their minds and bodies against distraction, laziness and addiction. Morning and evening routines discussed in the My Routine Tracker booklet also provide structure for users to complete methods from the other booklets. They can help users to “snowball” tasks—the more tasks that are achieved in the morning, the greater momentum the user may have the rest of the day. The creation of a user's morning and evening routine creates a daily anchor for the user.

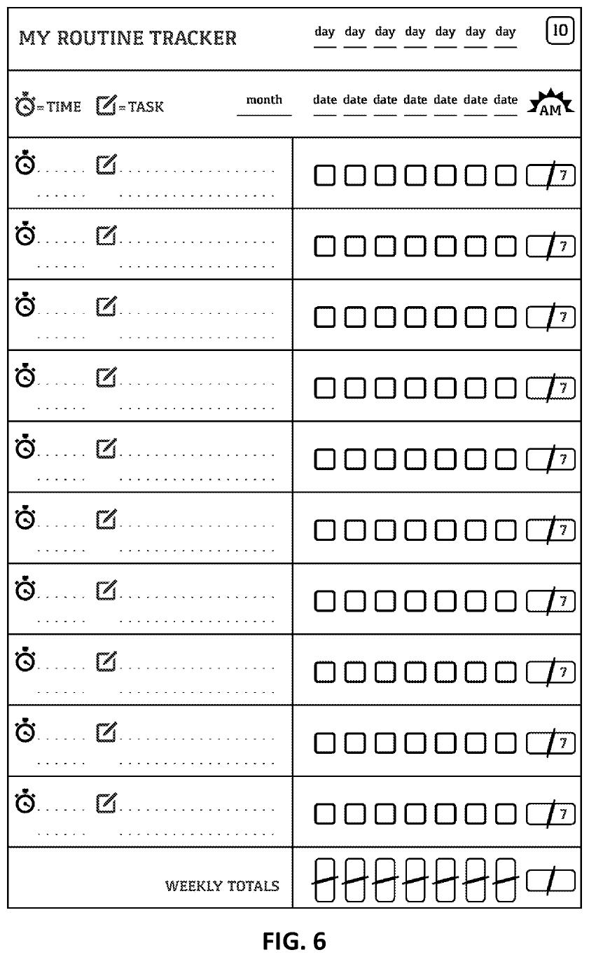

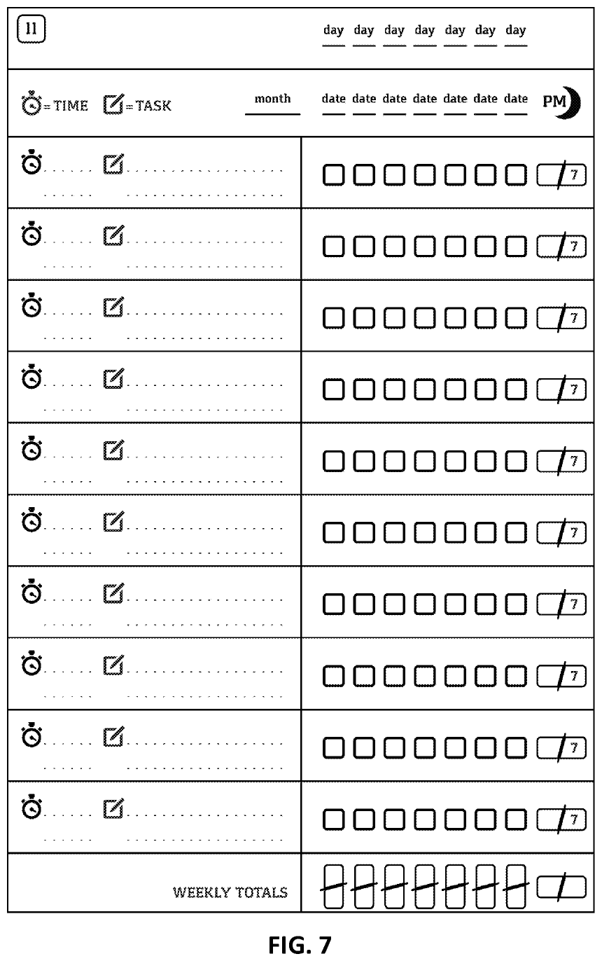

In implementations the My Routine Tracker booklet includes a number of blank morning routine pages such as that shown in FIG. 6. As can be seen from FIG. 6, the morning routine page includes fields for a user to input days, a month, and dates, along with a time, a task name, and checkmark boxes to indicate whether each task was performed. There are also fields for tallying the total number of days out of seven that each task was completed. At the bottom of the page there are fields for weekly total tallies for all of the tasks. FIG. 7 shows a blank evening routine page which is similar to the morning routine page. A number of the blank morning routine pages and evening routine pages are included in the My Routine Tracker booklet.

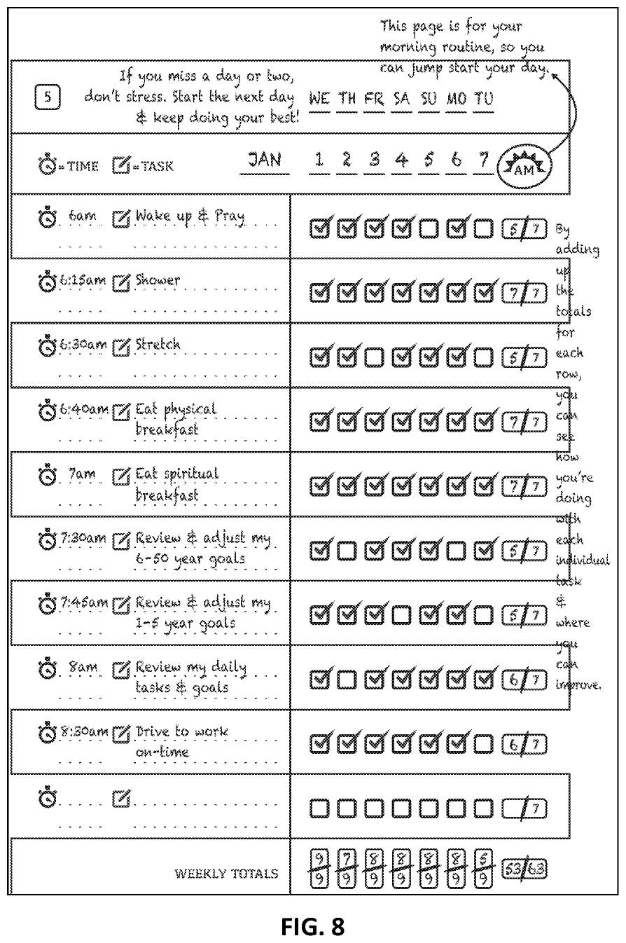

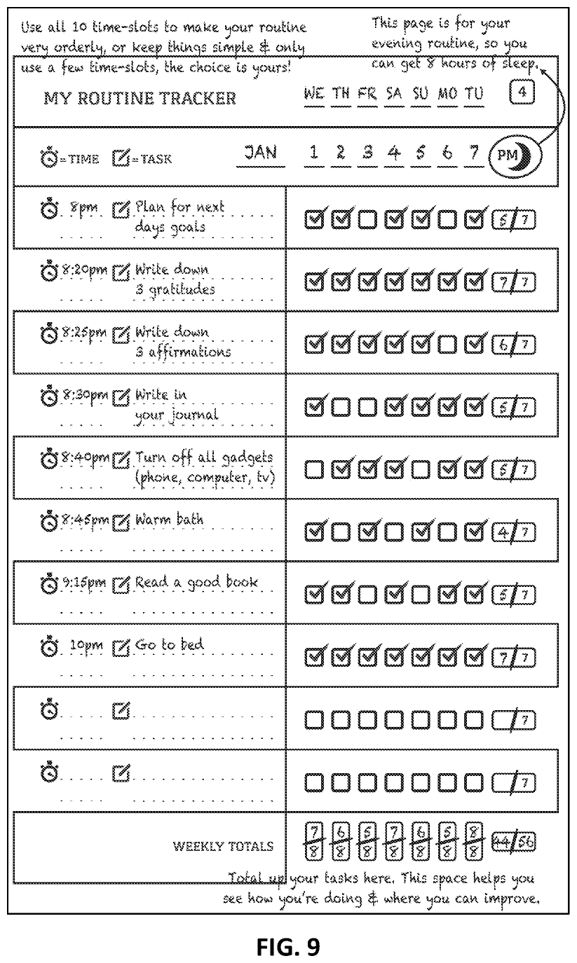

The My Routine Tracker booklet also includes example pages that include instructions and that give examples of how a user would fill out the morning and evening routine pages. FIG. 8 shows an example morning routine page with several days, a month, dates, times, and task names input. The user has input checkmarks and weekly tallies for each task, as well as total tallies at the bottom of the page. The tallying system allows the user to effectively have a score at the end of each week. The example morning routine page includes instructions. The weekly total for each task allows the users to see how they are doing on each task of the routine (or each task related to the routine), and which tasks could use improvement. FIG. 9 shows an example evening routine page similar to the example morning routine page, and also include instructions and several fields filled out to provide examples to a user regarding how to use the morning routine pages. A user could use all 10 time slots on each routine page, or fewer than all 10, as desired. The morning routine pages help a user start a day off right, and the evening routine pages help a user prepare for a full night of sleep. When the user tallies the totals at the bottom of the routine pages it helps the users see how they are doing from day to day and which days could use improvement.

The number at the top right of the morning routine page of FIG. 6 and at the top left of the evening routine page of FIG. 7 are simply page numbers. Appendix A only shows two morning and two evening routine pages, for brevity, and just a few blank pages, but in implementations there can be enough morning and evening routine pages in each My Routine Tracker booklet for a month or more of days, with interspersed blank pages (lined or unlined) between groupings of the routine pages, for users to write down their own notes as desired. In implementations the My Routine Tracker booklet (as with any of the other fillable booklets disclosed herein) can be removed and replaced when it is filled, so that the Planner System 100 always includes a current version of each booklet that is currently being filled out.

My Happiness Planner (Method and Calendar) Booklets

The My Happiness Planner (Method and Calendar) booklets are the foundation for the life balance ecosystem. They teach users how to nourish their minds and bodies, and the principles therein help guide users in setting goals and looking to the future of their lives. The method booklet outlines “5 Dimensions of Happiness.” The 5 Dimensions may be thought of as 5 key areas of the soul or of a person: spiritual, physical, intellectual, emotional and social. In order to create the most happiness in their lives, users are taught and helped to feed or focus on each of these dimensions appropriately. The method booklet outlines the “what” and “why,” while the calendar booklet is a daily calendar that allows individuals to implement the specific methods, outlined in the method booklet, of building happiness. As seen in Appendix B, the My Happiness Planner Method booklet has imagery of the ground and trees (and a leaf logo) on the outsides of the first and last pages to remind the user that this booklet is the “foundation” of the planner system, or of the life balance ecosystem (the first page in Appendix B represents the first and last pages of the booklet as it folds in the center to enclose all other pages of the booklet). As seen in Appendix C, the My Happiness Planner Calendar booklet has imagery of trees (and a leaf logo) on the outsides of the first and last pages to remind the user that this booklet facilitates the ongoing implementation of the “foundation” of the planner system, or of the life balance ecosystem (the first page in Appendix C represents the first and last pages of the booklet as it folds in the center to enclose all other pages of the booklet).

The My Happiness Planner Method booklet discusses 5 dimensions of happiness: spiritual; physical; intellectual, emotional, and social, and helps a user to create daily tasks in each of the five areas (to be written down and tracked using the My Happiness Planner calendar booklet, to be discussed later). The focus on these five areas helps users to live more balanced and happy lives by not focusing too much on one area/dimension of life and/or too little on another. For example we all need to work, but if we work so much that we rarely exercise or spend time with spouse, children, relative or friends, we are out of balance and will not be as happy. If we instead ensure that we can provide for our needs and those of our family but, also, have time to take care of ourselves spiritually, physically, intellectually, emotionally and socially, spending regular quality time with those we love for example, our lives will be more balanced and we will live happier lives.

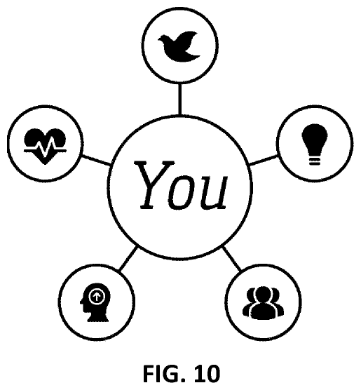

The My Happiness Planner Method and Calendar booklets include matching logos to represent the five areas. The five areas/dimension can be thought of as five aspects/dimensions of our happiness—so that happiness in all five dimensions results in greater happiness overall. Feeding or nourishing each of these five dimensions adds resilience and endurance to us. The logos are shown in FIG. 10, in which the dove/bird logo represents spiritual happiness, the heart logo represents physical happiness, the light bulb logo represents intellectual happiness, the head profile logo represents emotional happiness, and the group logo represents social happiness.

Spiritual happiness, as discussed in the My Happiness Planner Method booklet, can be increased by, as non-limiting examples: participating in religion and/or faith; connection and/or communication to or with a god or deity or higher power; studying scripture; praying; focusing on the needs of others; serving; being kind; comforting those who struggle; mourning with those in pain; loving others; keeping commitments to a god or deity or higher power; and so forth. Indications of a loss of spiritual happiness or lack of focus on the spiritual dimension (or in other words things that can decrease spiritual happiness) can include, by non-limiting examples: loss of faith; pride; selfishness; gossiping; envy; anger; loss of morality; and so forth. Starving oneself spiritually, or in other words not taking care of one's spiritual side, can have negative effects on the physical body as well.

Physical happiness, as discussed in the My Happiness Planner Method booklet, relates to choices of what one does and what one avoids doing related to the physical body. Physical happiness can be increased, for example, by non-limiting examples, by: healthy/correct eating; effective exercise; exercising self-control over cravings and addictions including determining triggers and working to keep good habits and remove bad ones—understanding that good habits may take time and may form slowly and must be practiced consistently and continuously; focusing on small wins; and foregoing harmful actions and substances.

Intellectual happiness, as discussed in the My Happiness Planner Method booklet, relates to challenging the brain to learn and develop new skills, reading, studying, learning/achieving wisdom, and so forth. Learning new things and pushing the limits of our brains strengthens our cognitive abilities and improves our perspectives. Intellectual happiness can also help us have more drive or passion or purpose for life or “ikigai,” roughly translated as “the reason for which you wake up in the morning.” Having a purpose in life can improve our quality of life and longevity (including longevity and increased health of our brains). A person's “ikigai” does not necessarily end upon retirement from a career—it can be career focused or not, it can be focused on a loved one, on a hobby on enjoys, or on any other endeavor. It can be something a person loves and which they can put their heart into. Intellectual happiness can be facilitated by a “growth mindset”—the idea that abilities can be developed and that challenges are opportunities instead of threats. Our minds have great ability to grow, and it is useful to believe they can grow instead of limiting our mental growth by our beliefs. The more knowledge and intelligence a person gains, the greater their advantage and perspective.

Emotional happiness, as discussed in the My Happiness Planner Method booklet, relates to the mind's ability to cope, adapt, and grow from stress and trials. Emotional happiness shapes a person's perspective on life and influences how the person sees others. Emotional happiness is improved/matured as a person learns to see life in a positive light. All people experience stress, struggles, trials and challenges—this adversity brings useful opportunities for strengthening the spirit, mind and body, for increasing one's grit, and for expand one's abilities. One useful way to see adversity as useful is by training the brain to see it through lenses of positivity and gratitude. What one person perceives as crippling adversity, another might perceive as empowering. Different belief systems and senses of worthiness can affect which perception/perspective a person has. Daily writing down things one is grateful for trains a person's brain to see the world in a positive light and helps individuals to have increased happiness, to feel more socially connected, to get more sleep and to get better quality of sleep. Gratitude can also make people more energetic, emotionally intelligent, forgiving, and less likely to be depressed, anxious or lonely. Running from trials may provide temporary relief, but such a defense mechanism can also harm us. Strength comes not by fleeing from our fears or avoiding our adversities, but by confronting our challenges, standing up to our struggles and believing in good things to come.

Social happiness, as discussed in the My Happiness Planner Method booklet, blossoms in quality relationships with family, friends and others, and improves longevity and quality of life. A 75-year Harvard study revealed that good relationships keep us happier and healthier. The study found: (1) those with larger social networks have increased health, happiness and longevity than those with smaller social networks; (2) it isn't just the size of the social network, but its quality—satisfaction of relationships is key in determining health as we age; and (3) good relationships protect not only our bodies, but also our brains—there is a profound effect on the brain when a person can truly count on key relationships. Similar effects were found in a Blue Zone Study led by Dan Buettner, which found incredible health benefits from friendship networks and from being generous and trustworthy with those friends. Keeping grandparents close to the family has been found to increase life expectancy by 4-6 years and to decrease disease and mortality rates for children of those families (called the “grandmother effect”). Building strong relationships and spending time with those you love accordingly increases social happiness and overall happiness.

The My Happiness Planner Method booklet encourages users to create and complete daily tasks that nourish each of the five discussed dimensions of happiness. Doing this over time allows people to build their own happiness. People who spend too much time in one area/dimension and/or neglect another they may rob themselves of potential happiness they could have obtained. The methods and steps of the My Happiness Planner Method booklet are to help a person maximize happiness by taking a balanced approach of focusing on each of the five dimensions of happiness. The booklet does not encourage people to divide life into five equal segments of time, but rather to learn to recognize what it feels like to be “hungry” in five slightly different ways, and taking the time and action necessary to feed that hunger until full. Motives are important, inasmuch as doing an activity because you want to do it changes your perception of the activity versus doing it because you feel forced to do it. Some activities can provide nourishment for two or more dimensions of happiness (or two or more dimensions of a person's being or soul). For example, going on a walk with family can nourish the physical dimension, the social dimension, and the spiritual dimension. Getting 8-9 hours of sleep can feed the physical dimension and the emotional dimension. Even so, the booklet encourages users to complete 5 different tasks each day, even though there may be overlap within tasks (for example “going on a walk” may be listed three times per the above example)—by setting 5 tasks a day, users keep each dimension in the forefront of their minds. As a user continues setting tasks and completing them the user can comprehend better how his/her soul “functions,” or in other words the user can become more aware of his/her own needs and “hungers” for each dimension, and of the time required to feed each dimension, and will be able to respond more quickly to feeding each of those hungers.

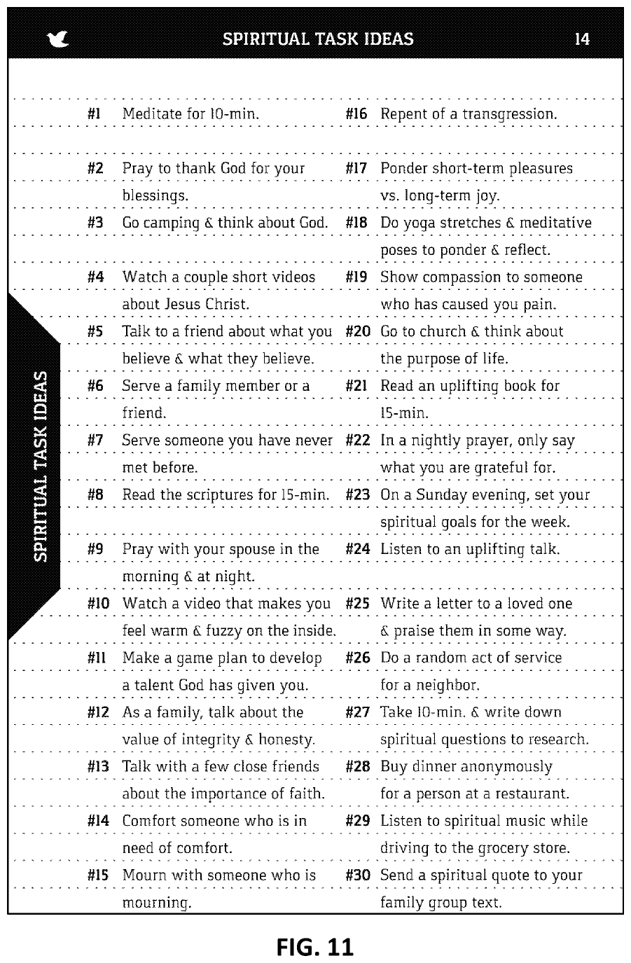

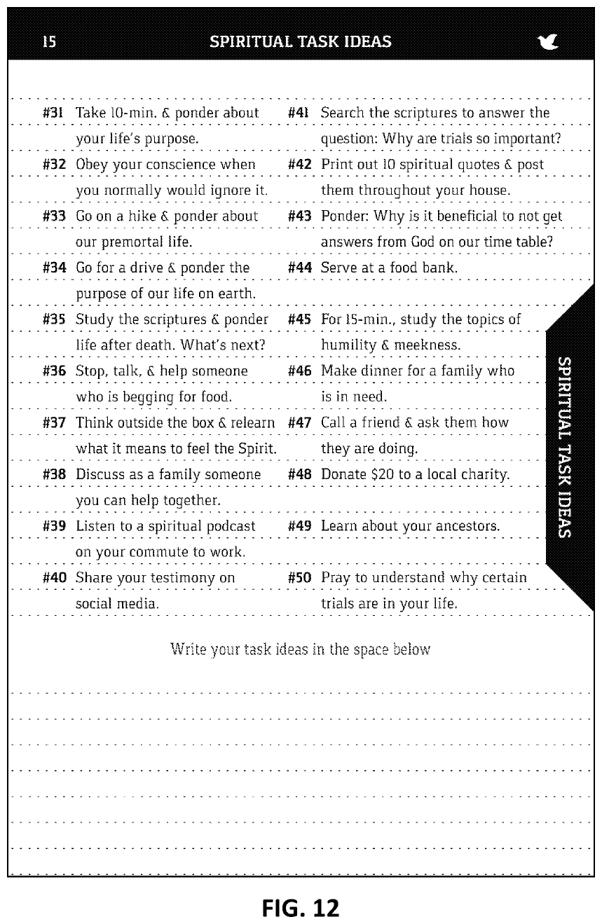

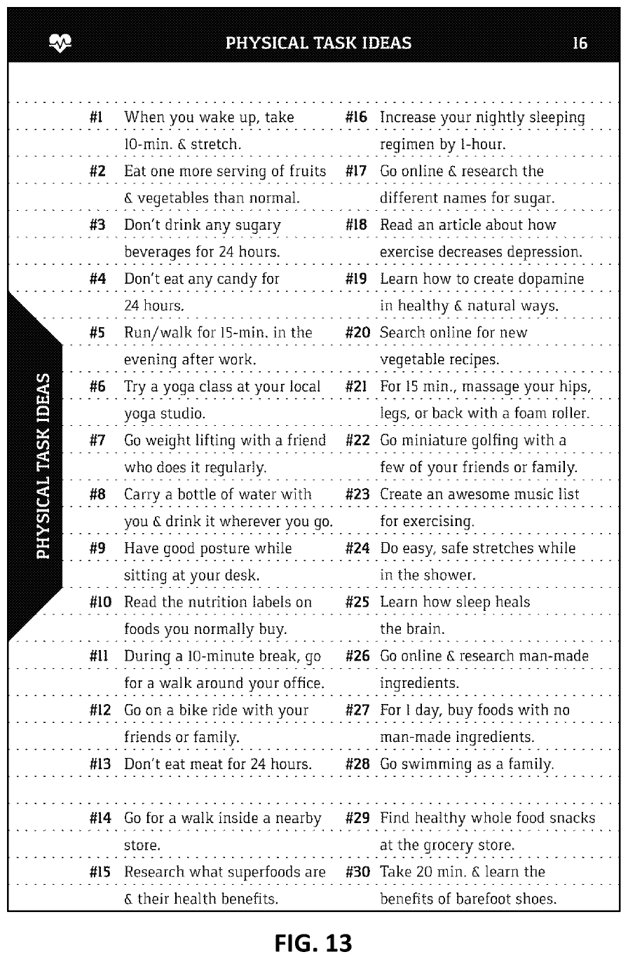

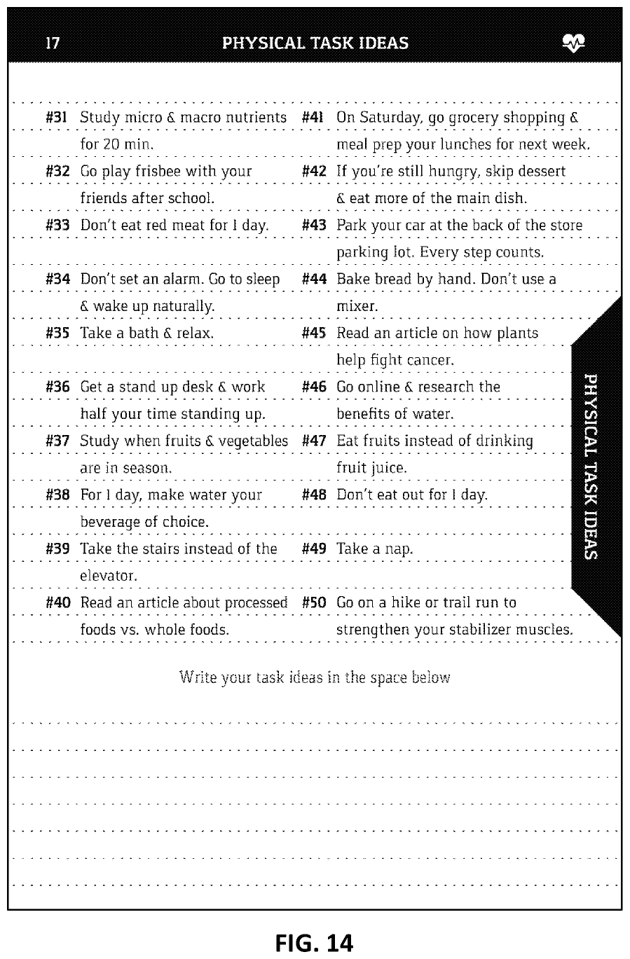

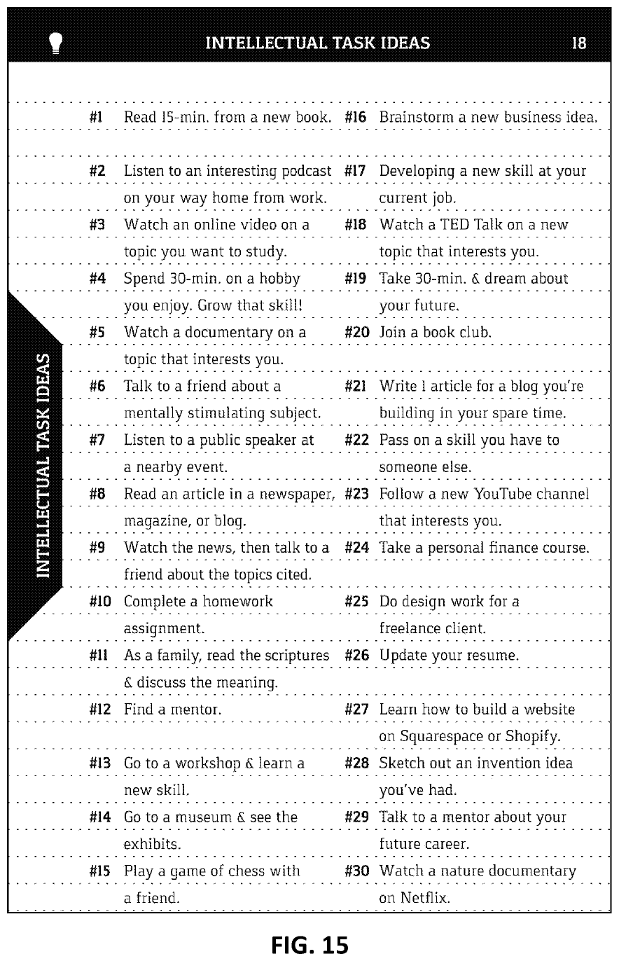

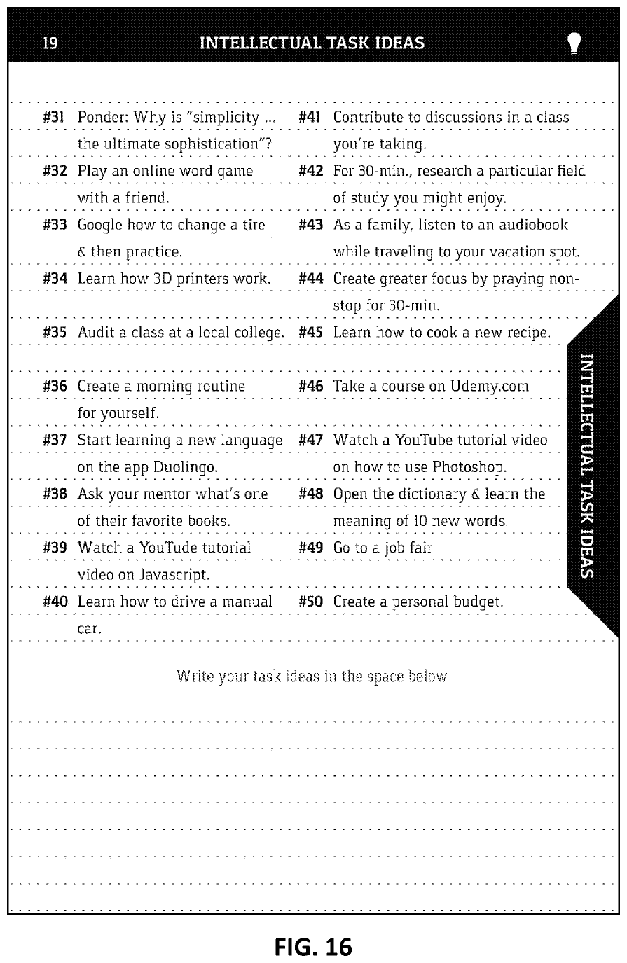

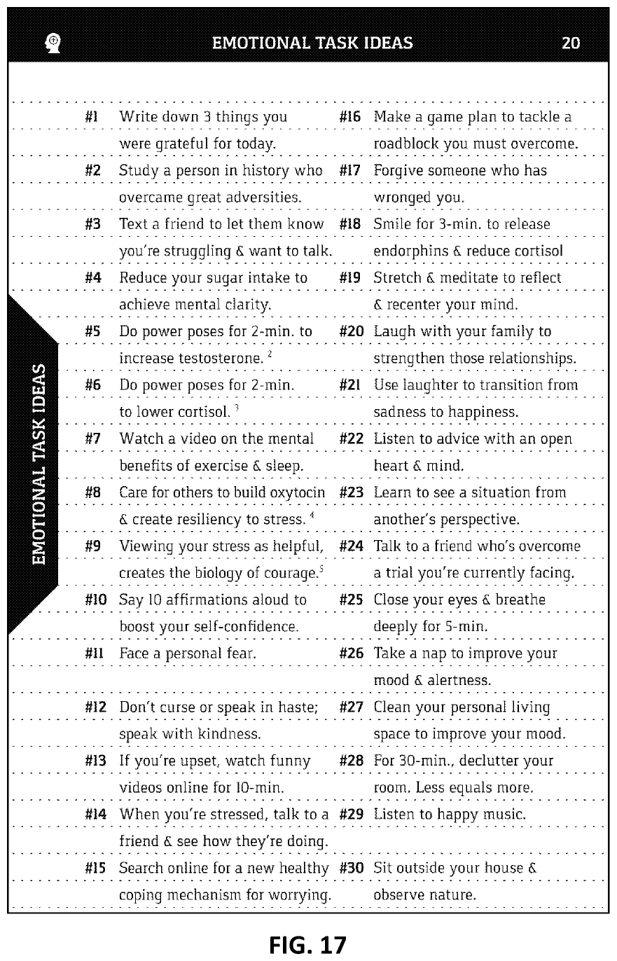

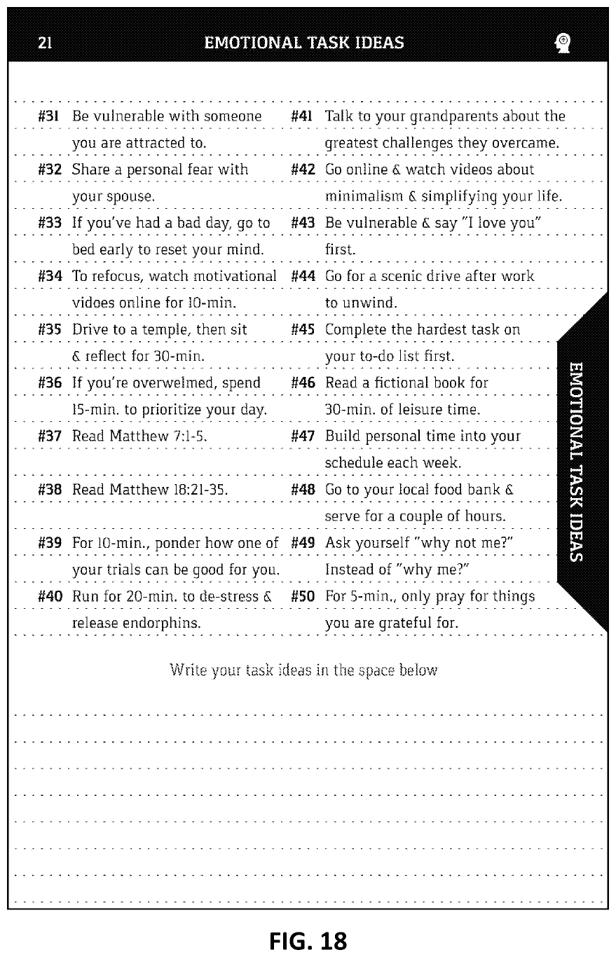

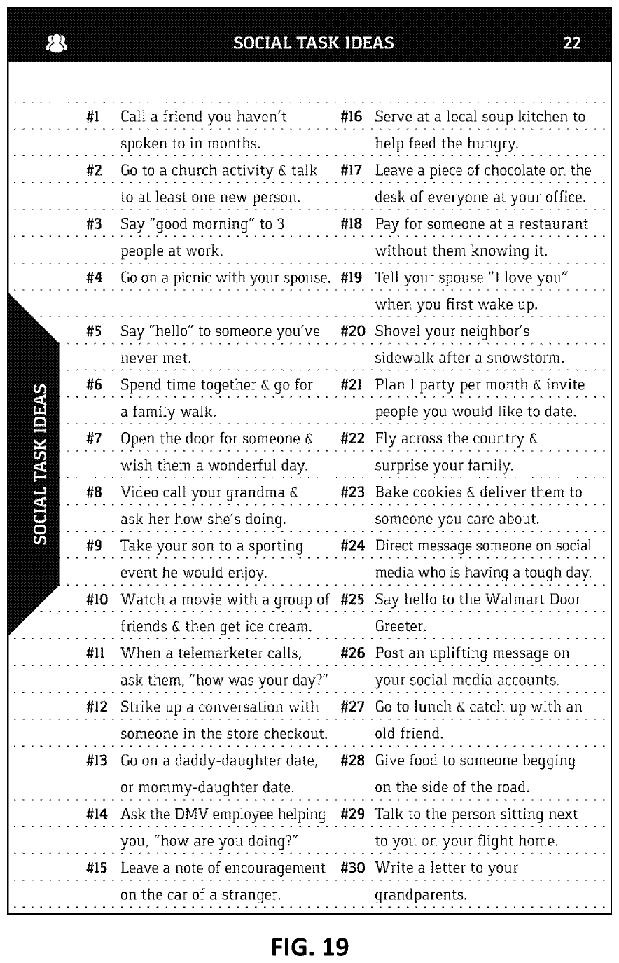

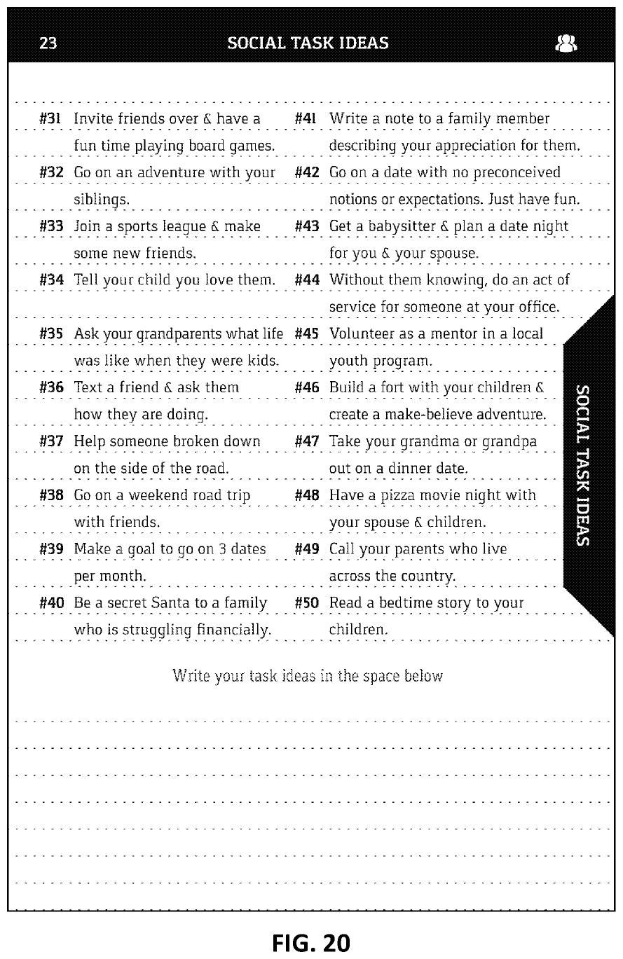

The My Happiness Planner Method booklet includes several pages with task ideas for the different dimensions. FIG. 11 shows a page (numbered page 14) which gives some spiritual task ideas. FIG. 12 shows a page (numbered page 15) which gives additional spiritual task ideas and which also includes space for users to write down their own spiritual task ideas. FIG. 13 shows a page (numbered page 16) which gives some physical task ideas. FIG. 14 shows a page (numbered page 17) which gives additional physical task ideas and which also includes space for users to write down their own physical task ideas. FIG. 15 shows a page (numbered page 18) which gives some intellectual task ideas. FIG. 16 shows a page (numbered page 19) which gives additional intellectual task ideas and which also includes space for users to write down their own intellectual task ideas. FIG. 17 shows a page (numbered page 20) which gives some emotional task ideas. FIG. 18 shows a page (numbered page 21) which gives additional emotional task ideas and which also includes space for users to write down their own emotional task ideas. FIG. 19 shows a page (numbered page 22) which gives some social task ideas. FIG. 20 shows a page (numbered page 23) which gives additional social task ideas and which also includes space for users to write down their own social task ideas.

The My Happiness Planner Method booklet discusses various other ideas related to happiness (including other ideas related to the five dimensions/aspects of happiness) and provides various quotes from, and citations to, references related to happiness and/or the five dimensions/aspects of happiness. The My Happiness Planner Method booklet also includes blank pages (lined or unlined) at the end and/or interspersed throughout for the user to write down any thoughts or notes, as desired.

The My Happiness Planner Calendar booklet is used for a user to organize selected tasks in the five areas throughout each week—for example one task every day for each dimension. A user can have the same five tasks every day for two weeks, or have a different task every day for each dimension, and so forth. The writing down of the tasks using the My Happiness Planner Calendar booklet helps to build new habits—it tells the mind that their behavior matters, and through consistency the user develops a routine that becomes deeply ingrained in the brain—with the goal of the habit becoming automatic. Once a habit becomes automatic, it is much more difficult to go back to old ways. By scheduling daily tasks and achieving them, users are the architects of their own happiness.

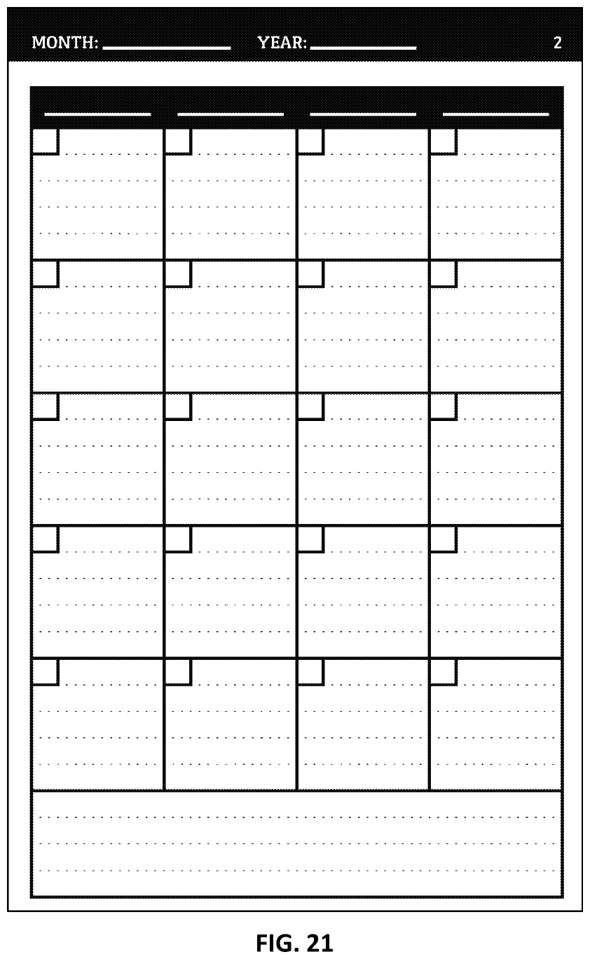

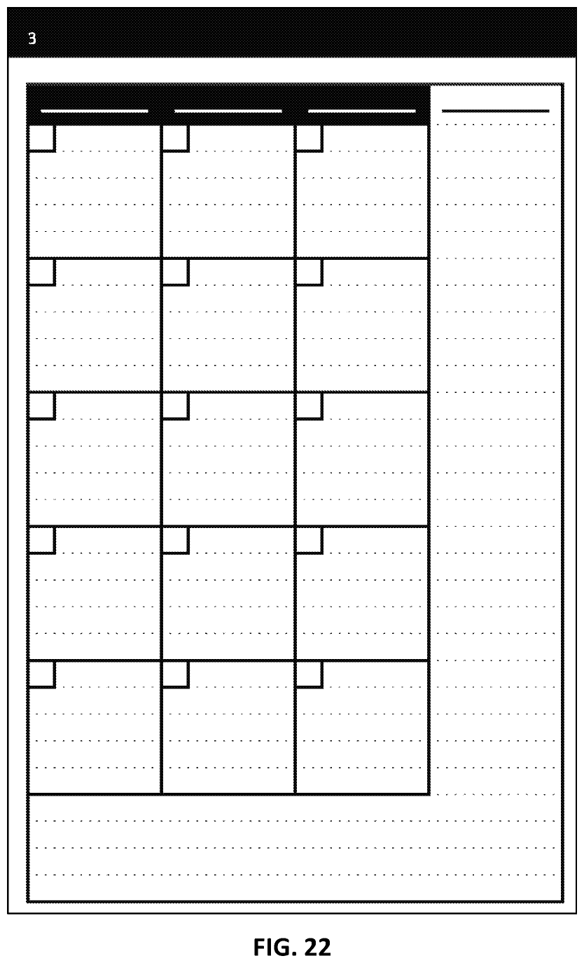

FIG. 21 shows a page (numbered page 2) of the My Happiness Planner Calendar booklet which is part of a monthly overview calendar on which a user can schedule appointments or the like. There are places for a user to insert a month, year, days of the week, and the specific dates of the month, as well as notes for any day. There is also a place for the user to place notes at the bottom of the calendar that may not be specific to any day of the month. FIG. 22 shows a page (numbered page 3) which is the other part of the monthly overview calendar (as they are on adjacent pages when a user opens the booklet to see both pages side by side they together form a monthly calendar). This other part of the monthly calendar has similar elements as those of FIG. 21 and also includes a space at the right of the calendar for notes that may not be related to any specific day.

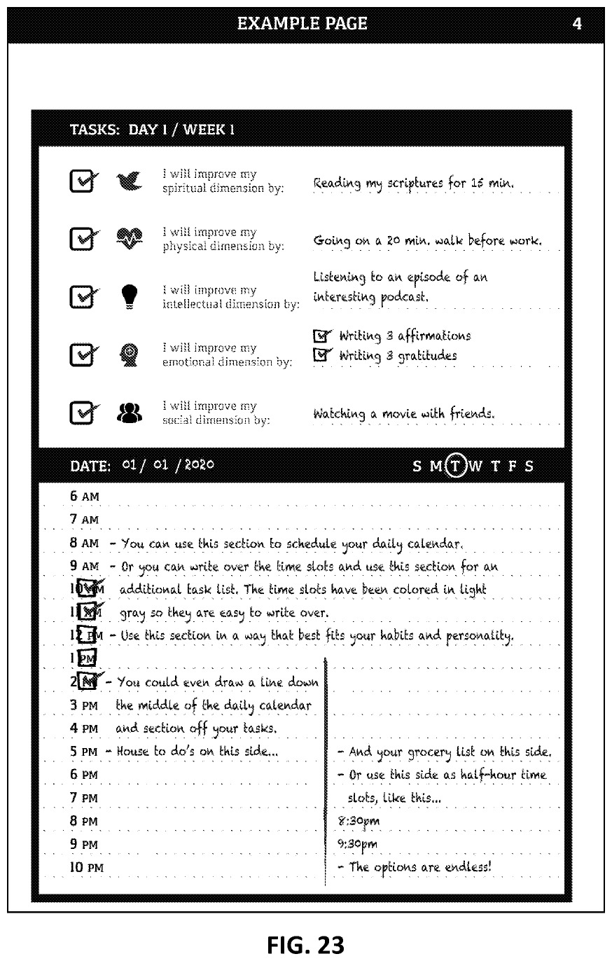

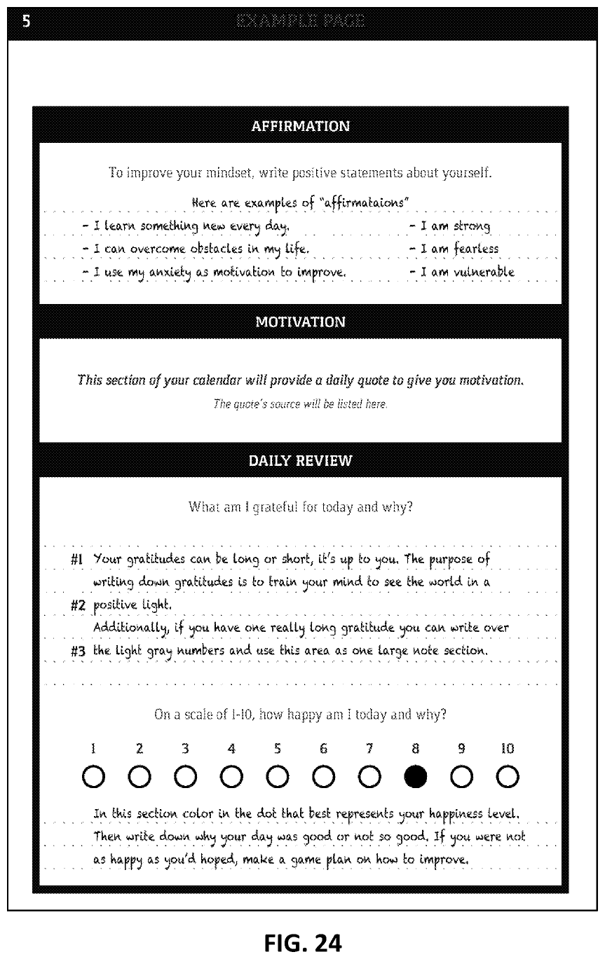

The My Happiness Planner Calendar booklet includes a daily section for each day of the month. These are separated out into groups of seven and are each followed by weekly review pages (for example there are seven daily sections for the first seven days of the month followed by a first weekly review section, then seven more daily sections for the next seven days followed by a second weekly review section, and so on). FIG. 23 shows an example of a filled first page (numbered page 4) of one of the daily sections—this example page is included in the My Happiness Planner Calendar booklet and helps the user know how to fill out the daily section. It can be seen that the user has written down specific tasks for each of the five areas and has checked them off as completed. These tasks can be seen as tasks related to self-improvement or tasks related to increasing happiness. There is a date and day section where a user can input the date and indicate the specific day of the week (the shades shown in the drawings are only examples—in implementations the booklet may be designed so that any markings may be made in pencil or any colored ink and show up as easily visible to indicate the date/day and anything else—the white ink on a black background is only one example). There is also an hourly schedule on which the user can schedule items or appointments, or the user could use this space for additional tasks, and so forth. The example page includes instructions and examples/ideas of ways to use the hourly section and the other portions (for example in the intellectual task section it is shown that a user created two sub-tasks which are each checked off as done). FIG. 24 shows an example of a filled second page (numbered page 5) of the same daily section—this page is also included in the My Happiness Planner Calendar booklet to help the user know how to fill this page. It can be seen that there is a section for the user to write down affirmations (which includes some example affirmations), another section for a motivational quote, another section for the user to write down what they are grateful for (with some example items written down), another section for the user to rate his/her happiness on a scale from 1-10 (including ideas/instructions of how to rate happiness), and some blank space for the user to write any other notes.

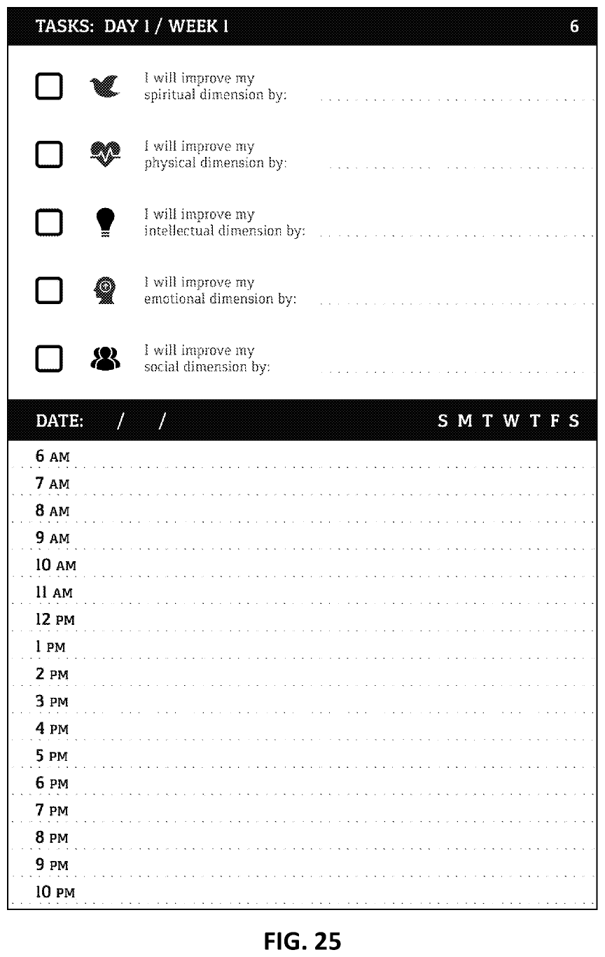

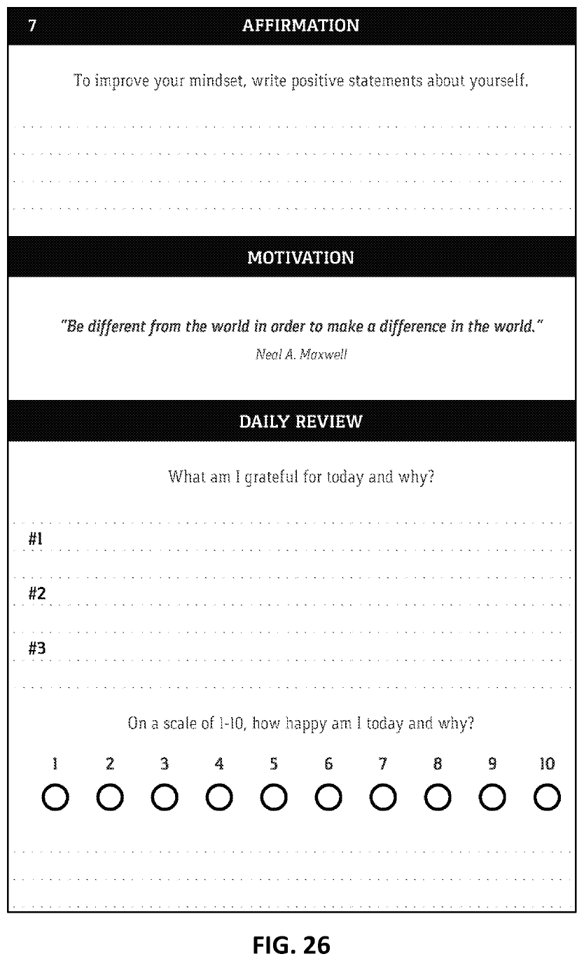

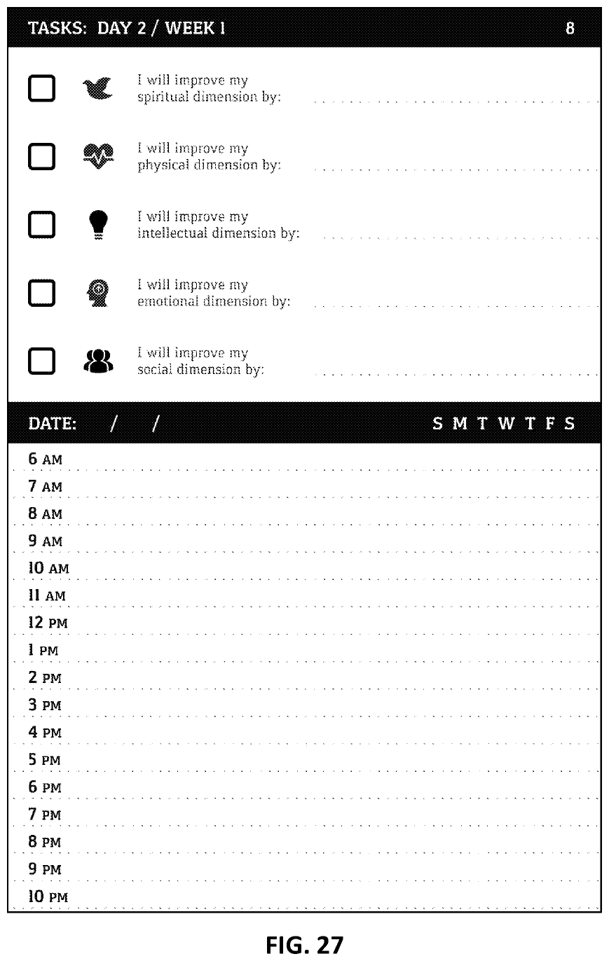

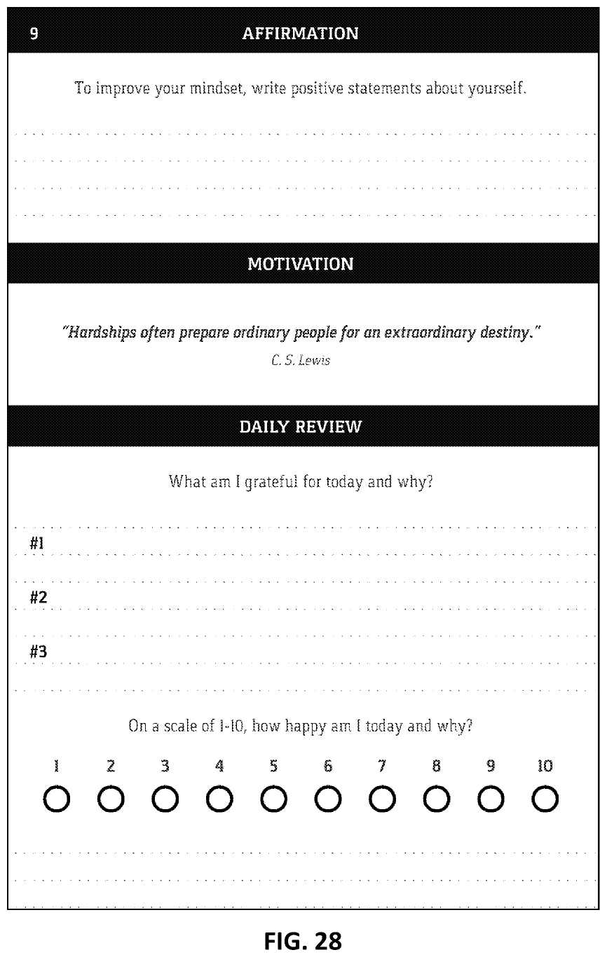

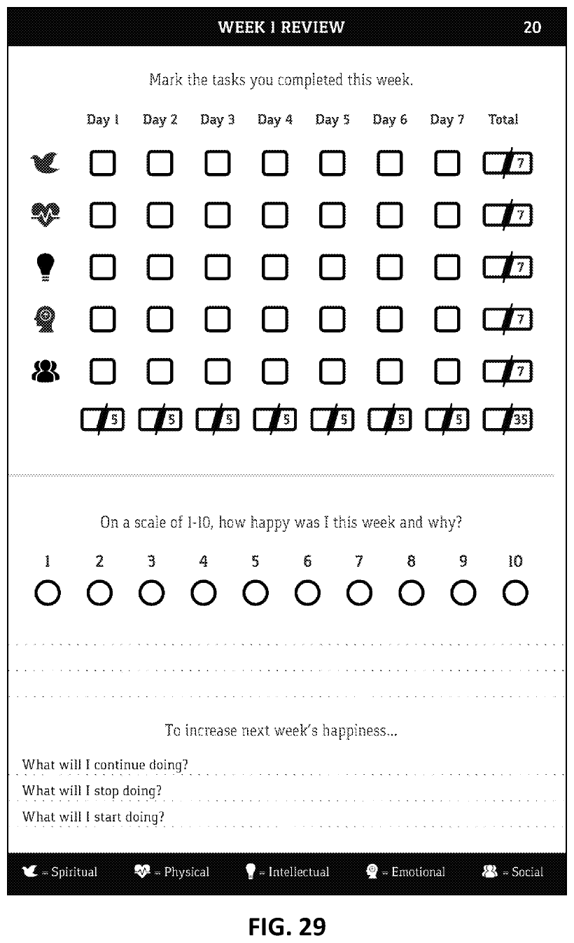

FIG. 25 shows a first page (numbered page 6) of one of the daily sections (this one is Day 1, Week 1) with the same portions as described above, but not yet filled out. FIG. 26 shows a second page (numbered page 7) of the same daily section with the same portions as described above, but not yet filled out (and including a quote). FIGS. 27-28 show the first and second pages (numbered pages 8 and 9) of a daily section for Day 2, Week 1, which is nearly identical and includes a different quote. Similar pages are included for Days 3-7 of Week 1, after which a weekly review section is included. FIG. 29 shows a first page (numbered page 20) of a weekly review section for Week 1. This section allows the user to mark down with checkboxes (or the like) which tasks were completed in each of the five dimensions for each day of the week. A tally/total at the right allows the user to input how many days out of the week each specific dimension's task was completed. A tally/total at the bottom allows the user to input how many of the dimensions (out of all 5) had their tasks completed each day. The tallies allow the user to determine which days they are not doing as well, and also which dimensions they are not doing as well on. The weekly review section also includes a scale allowing the user to rate their happiness, a place for some notes, and a place for the user to fill out what they will continue doing, stop doing, and start doing to increase the next week's happiness. Each weekly review section also includes another page (not shown in the drawings) which is just a blank lined page for the user to write down other notes. FIG. 29 shows that the weekly review section includes a key at the bottom correlating each of the happiness dimension logos with the specific area/dimension of happiness (spiritual, physical, etc.). The weekly review section allows users to have some accountability on how they are feeding their souls and/or the different areas/dimensions of their happiness, and to make plans on how to improve moving forward.

After the first weekly review section are daily sections for the next week (Day 8/Week 2; Day 9/Week 2; etc.) followed by a weekly review section for the second week (Week 2 Review). This pattern continues for the third week, fourth week, and fifth week (for months which include a fifth week). The My Happiness Planner Calendar booklet can easily be replaced within the overall planner system 100 each month (swapping a used one out for a blank one when one month transitions to another) to keep the thickness of the planner system from increasing over time, or the user could leave multiple of the My Happiness Planner Calendar booklets (for example a year's worth or more) within the planner system 100 to more easily track and review progress over periods longer than a month. Because the system more easily accommodates multiple booklets in groups of two (as discussed relative to FIG. 5), the user may most easily include more than one My Happiness Planner Calendar booklet by rounding up the number of My Happiness Planner Calendar booklets so that the total number of booklets (within the entire planner system 100) add up to an even number.

My Dream Big Planner (My Dream Planner) Booklet

The My Dream Planner helps users become more advanced in their goal-setting skills and guides their happiness building to a broader scope. The My Happiness Planner helps users to set and achieve goals on a daily and/or weekly timeframe (in other words it focuses on goals meant to be completed within one or more days or one or more weeks). This helps the individual nourish the soul or the person in the here and now. On the other hand the My Dream Planner helps the user set goals meant to be completed within six months to multiple years. This planner accordingly helps the user begin with the end in mind and plan from the future backwards until the present day. Users start with a “summit” they want to climb and then work their way back (mentally) setting interim goals until they are at the “bottom” of the “mountain,” so to speak. As seen in Appendix D, the My Dream Big Planner booklet has imagery of tree-filled hills in the foreground and large mountains in the background (and a logo of mountain peaks including a snow-capped peak) on the outsides of the first and last pages to remind the user that this booklet focuses on the “mountain” goals or, in other words, larger and more long-term goals (the first page in Appendix D represents the first and last pages of the booklet as it folds in the center to enclose all other pages of the booklet).

The My Dream Planner helps people become more advanced in their goal setting skills and guides their happiness building to a broader scope. In the My Happiness Planner (Method and Calendar) booklets, the purpose is to achieve tasks within a day, week or single month. This is to help an individual nourish the soul in the here and now. The My Dream Planner, on the other hand, helps the user set goals from 2-3 months to multiple years. The My Dream Planner helps the user begin with the end in mind and plan backwards from the future until the present day. The user starts with the “summit” that the user wants to “climb” and works back (mentally) until at the bottom of the “mountain.” Once a user has designed a summit and defined goals from the top down, the user can switch gears and use what are called MBS Pages (Milepost, Base Camp & Summit Pages) to plan Daily Climb tasks. The user does this by starting from the bottom of the mountain and then moving upward. This booklet is a very visual way to see the user's goals. In conjunction with the entire planner system (life balance ecosystem), the user is enabled to envision their future like never before.

The My Dream Planner accordingly uses the following terminology: Summit (a big dream/goal the user is wanting to achieve); Base Camp (the halfway point to reaching the Summit); Mileposts (major steps in between the foot of the “mountain” and the Base Camp, and in between the Base Camp and the Summit); The Daily Climb (smaller tasks and projects in between the Mileposts, Base Camp and Summit—the small building blocks in between the bigger checkpoints along the path to the big dream/goal). The My Dream Planner also uses logos/images to represent each of these, with the Summit having a logo/image of a flag atop a mountaintop, the Base Camp having a logo of a tent, the Mileposts having a logo/image of a post with signs on it, and the Daily Climb having a logo/image of a hiker.

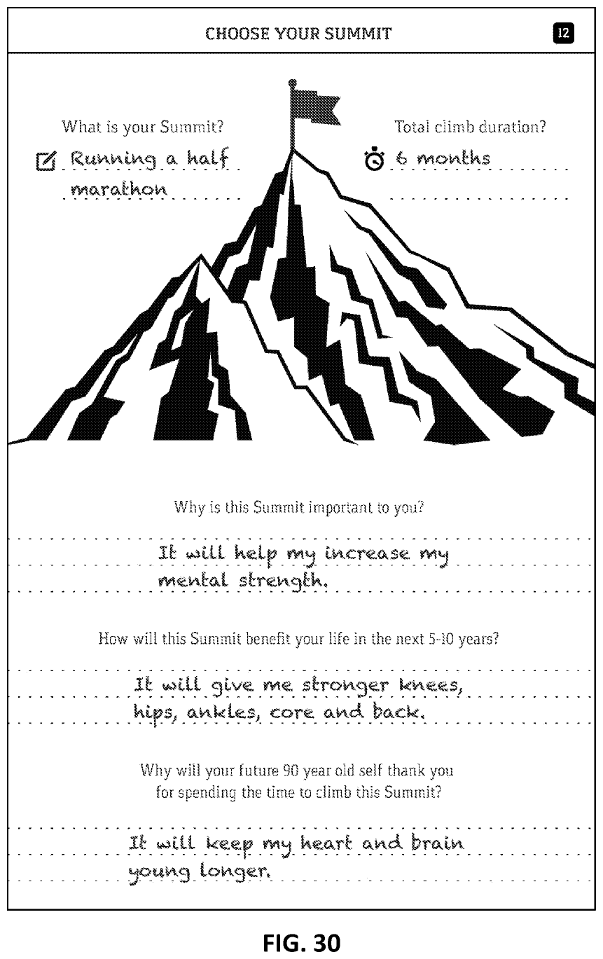

FIG. 30 shows an example Choose Your Summit page of the My Dream Planner. This page (having a page number 12 in Appendix D) includes an image of a summit and includes a location for a user to indicate the summit (or in other words big goal/dream), a “total climb duration” (in other words how long the person will take to achieve the goal), why the summit is important to the user, how the summit will benefit the user's life in the next 5-10 years, and why the user's future 90-year old self will thank the user for spending the time to climb this summit. FIG. 30 is an example page that is included in the My Dream Planner to give the user an example of how to fill out the page.

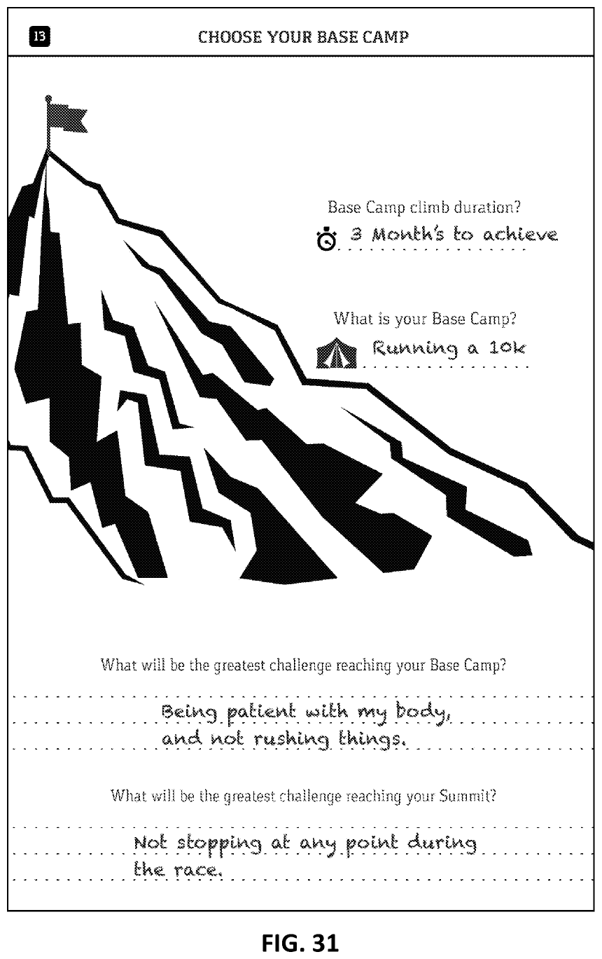

FIG. 31 shows an example Choose Your Base Camp page of the My Dream Planner which includes an image of the summit along with an image of the base camp (tent logo), plus places to input a base camp climb duration (time to achieve the base camp halfway goal), a definition of the base camp, what the greatest challenge will be reaching the base camp, and what the greatest challenge will be reaching the summit. FIG. 31 is an example page that is included in the My Dream Planner to give the user an example of how to fill out the page.

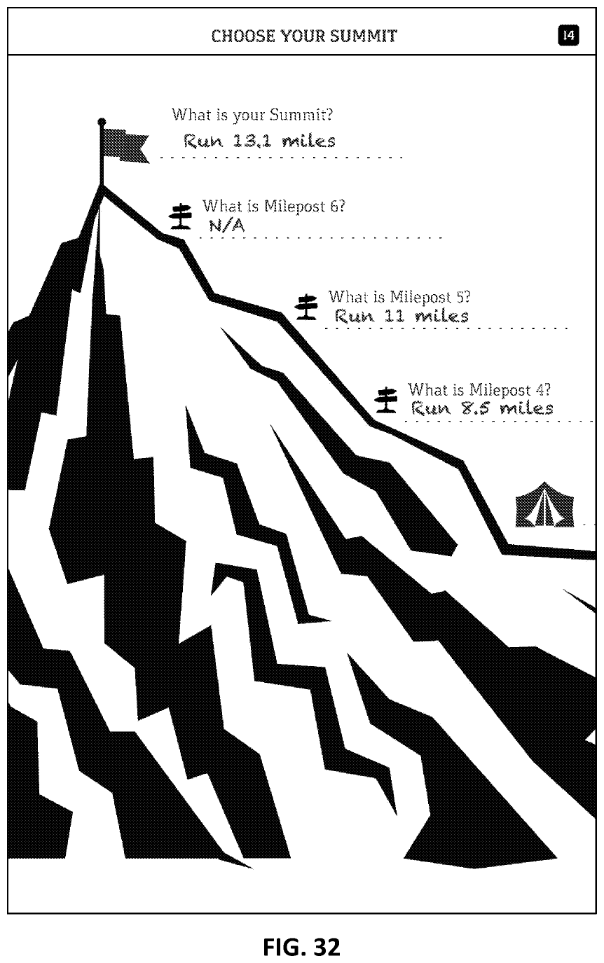

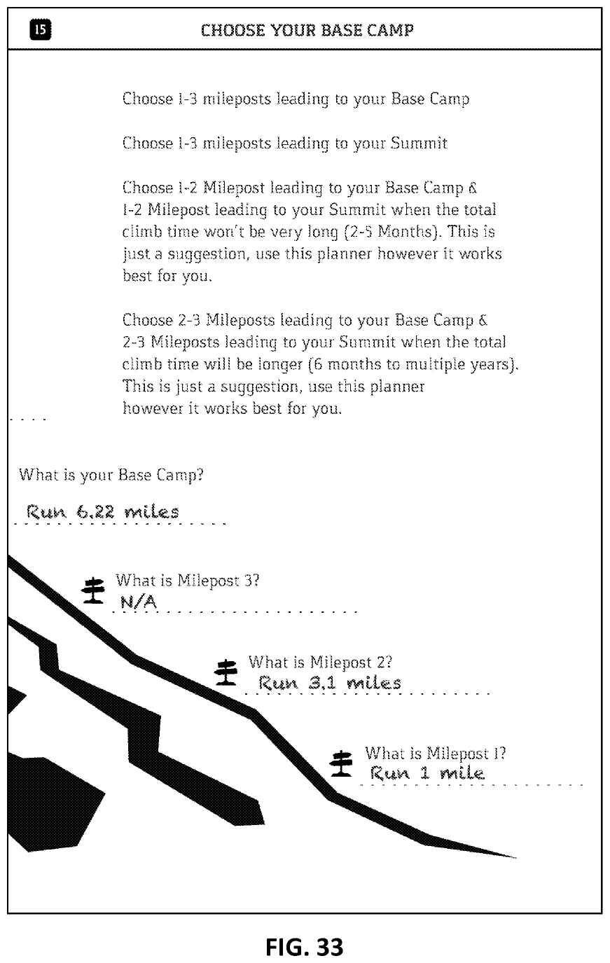

FIGS. 32-33 show two pages (which actually form one combined image when the user opens up to them) whereon, after a user has chosen the summit and base camp, the user inserts the summit, the base camp, and six mileposts (if applicable) including three mileposts before the base camp and three mileposts between the base camp and the summit. There are also instructions that if the summit time is shorter (2-5 months, for example) the user could instead choose, as an example, 1-2 mileposts between the base of the mountain and the base camp and, similarly, 1-2 mileposts between the base camp and the summit. There are further instructions that if the summit time is longer (6 months to multiple years, for example) the user could choose, as an example, 2-3 mileposts between the base of the mountain and the base camp and, similarly, 2-3 mileposts between the base camp and the summit. These instructions are, however, indicated as only suggestions, with an indication that the user can use the booklet however they want. FIGS. 32 and 33 are example pages that are included in the My Dream Planner booklet to give examples of how a user would fill out these pages. The pages allowing a user to first pick a summit, then a base camp, then mileposts, allow the user to begin with the end in mind, then to work backwards preparing intermediate goals to reach the summit, then to plan mileposts and to be able to visually see the whole picture from the present day until the large goal is reached.

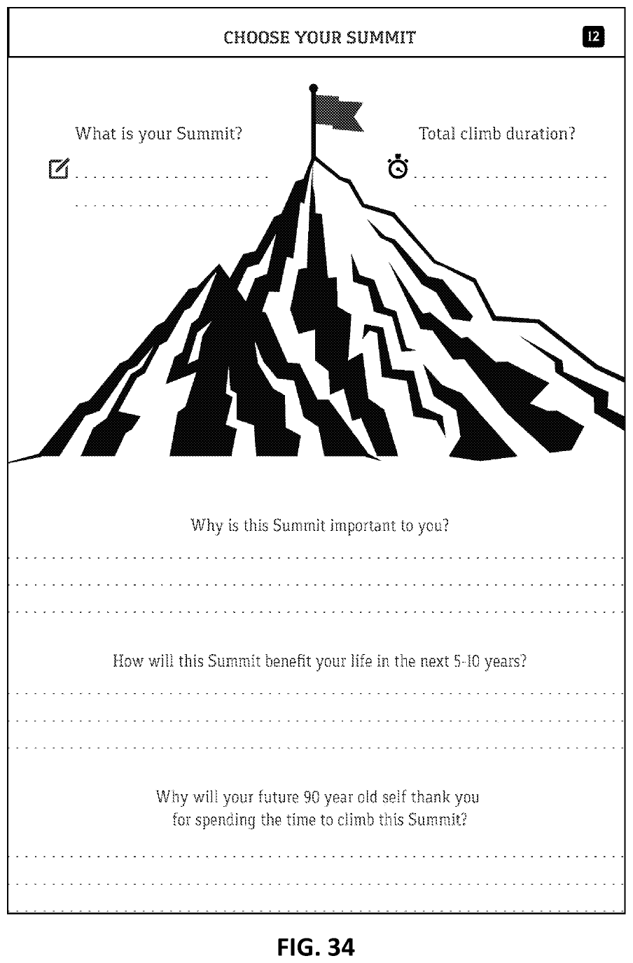

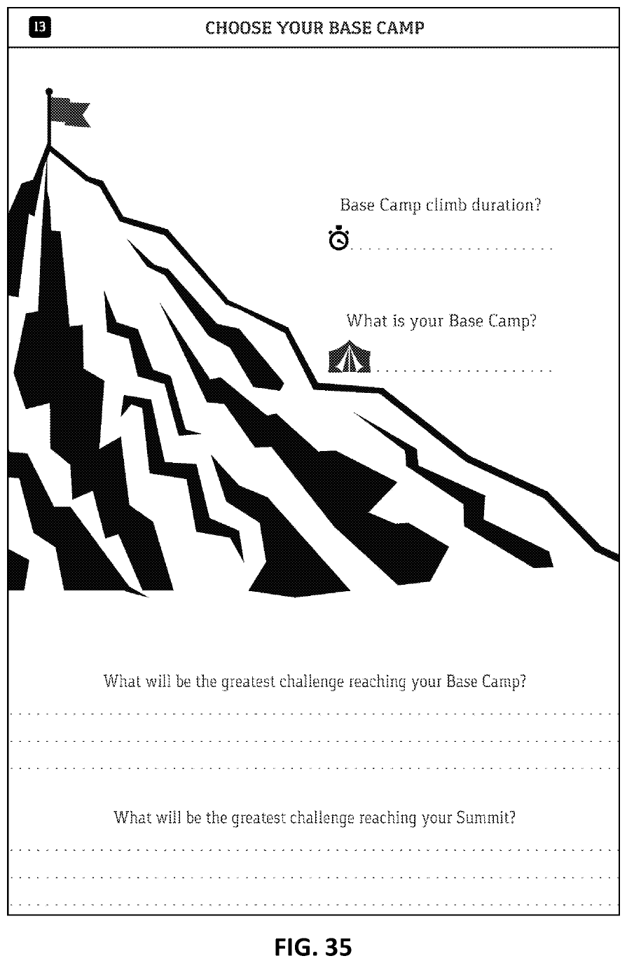

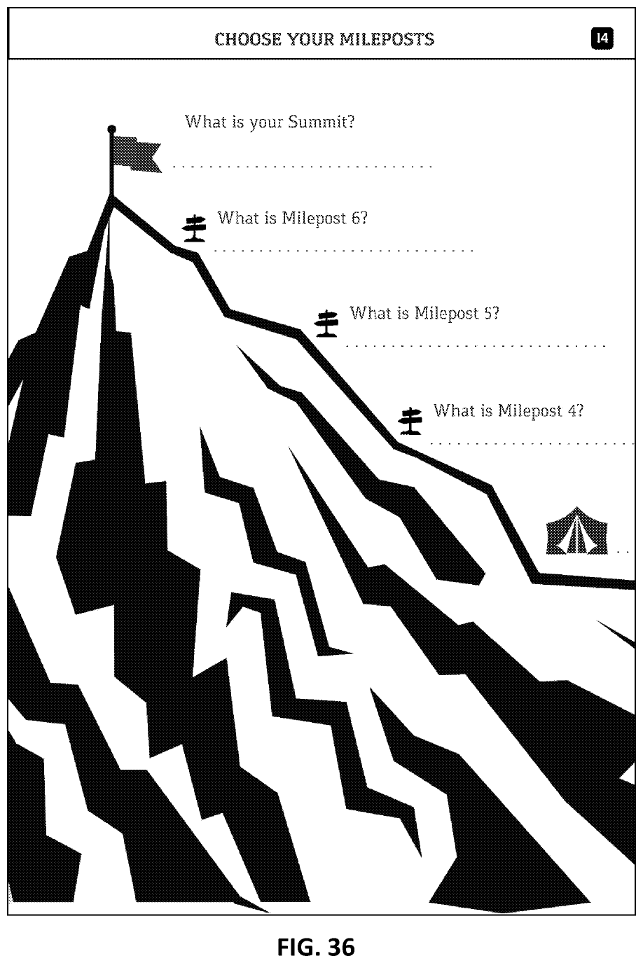

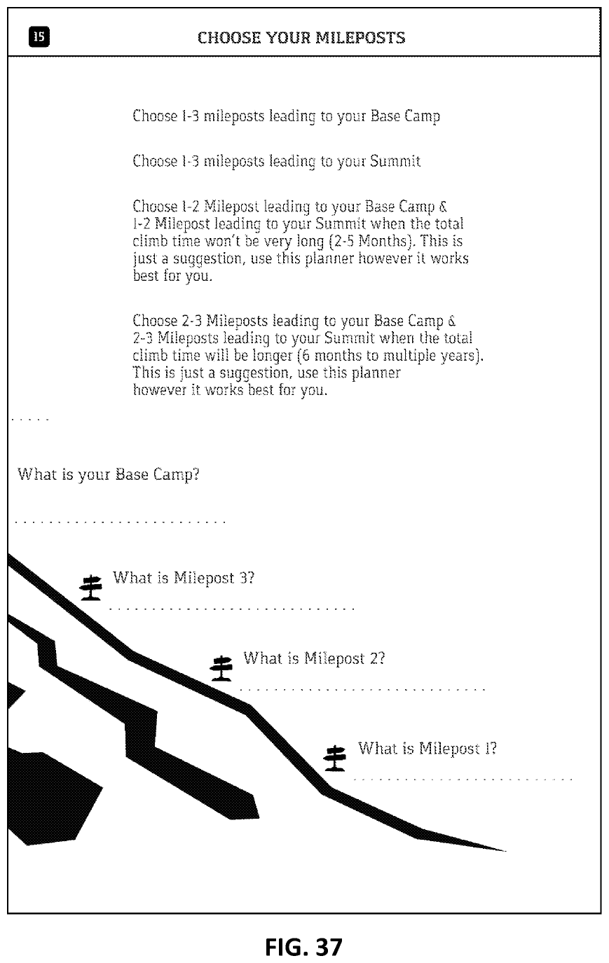

FIGS. 34-37 show pages similar to the pages of FIGS. 30-33 except blank, ready for a user to fill them out.

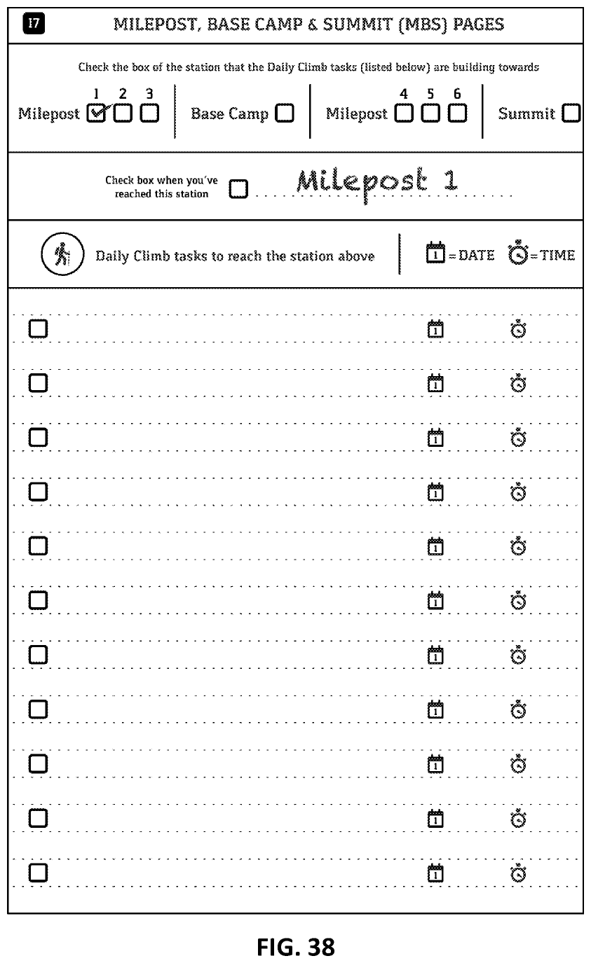

FIG. 38 shows an example Milepost, Base Camp & Summit (MBS) page that is included in the My Dream Planner booklet and is partially filled out to show the user how this page would be used. The user checks a checkmark to indicate which “station” this page is for (one of the mileposts, or the base camp, or the summit. The specific station (in this case, “Milepost 1”) is also written in another space and a checkbox is included for the user to check off when the station is reached. There are also spaces for the user to indicate “Daily Climb” tasks to reach the station, each with a checkbox, as well as a date and time for each. The user can use the MBS page to come up with smaller tasks (smaller than a milepost) that are in between stations. The “time” fields can be used to input the time of the day in which the daily climb task will be completed or the amount of time the task will take (or the amount of time it did take), according to user preference. Each station could include multiple daily climb tasks, dated for different days as the user desires. In implementations a user could use more than one MBS page for each station, if needed or desired—the user has freedom to construct their journey the way it needs to be, giving them the highest likelihood of reaching the summit. The MBS pages are customizable and can be used to fit any summit (or any station on the way to the summit) that the user has come up with or defined. The MBS pages help the user to plan from the foot of the mountain going upward (after the user has, using the prior pages, planned the larger tasks from the summit of the mountain going downward).

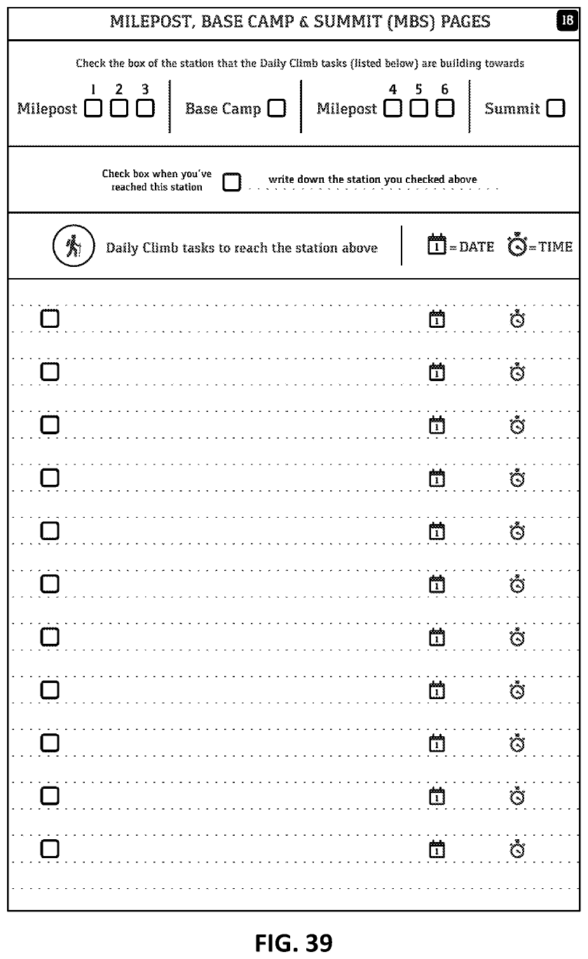

FIG. 39 shows an MBS page similar to FIG. 38 except fully blank, ready for a user to fill out. In Appendix D there are only 4 MBS pages shown for each summit but this is only for brevity—in implementations 10 or 20 or MBS pages (or fewer or more) will be included for each summit.

In implementations each My Dream Planner includes multiple overall summit sections (each including a Choose Your Summit page, a Choose Your Base Camp page, MBS pages, and so forth) so the user can use each My Dream Planner booklet to accomplish multiple summits. In implementations there are many MBS pages (for example, sixteen) for each summit, so that a user can use the MBS pages as needed for each station (and multiple for one or more stations, if needed). There are also some blank (lined or unlined) pages in the My Dream Planner booklet, (such as several at the end of each overall summit section and several at the very end, as well as others interspersed throughout), for the user to make notes and the like.

My Lifetime Planner Booklet

The My Lifetime Planner booklet helps people see their lives from “the clouds” or see the big picture or, in other words, it helps uses see their lives and envision their future from a lifetime perspective. One key to longevity is doing things your 90 year old (future) self will thank you for. For example, if you are 30 and want the health and happiness benefits of being a grandparent at 60 years old you may need to start dating this year, marry next year, and have a child within 3 years so the child can be out of the house in 20 years, have 4 years to find a spouse, and 1 year thereafter to have a child (your grandchild). As seen in Appendix E, the My Lifetime Planner booklet has imagery of clouds (and a cloud logo) on the outsides of the first and last pages to remind the user that this booklet focuses on a larger perspective (the first page in Appendix E represents the first and last pages of the booklet as it folds in the center to enclose all other pages of the booklet).

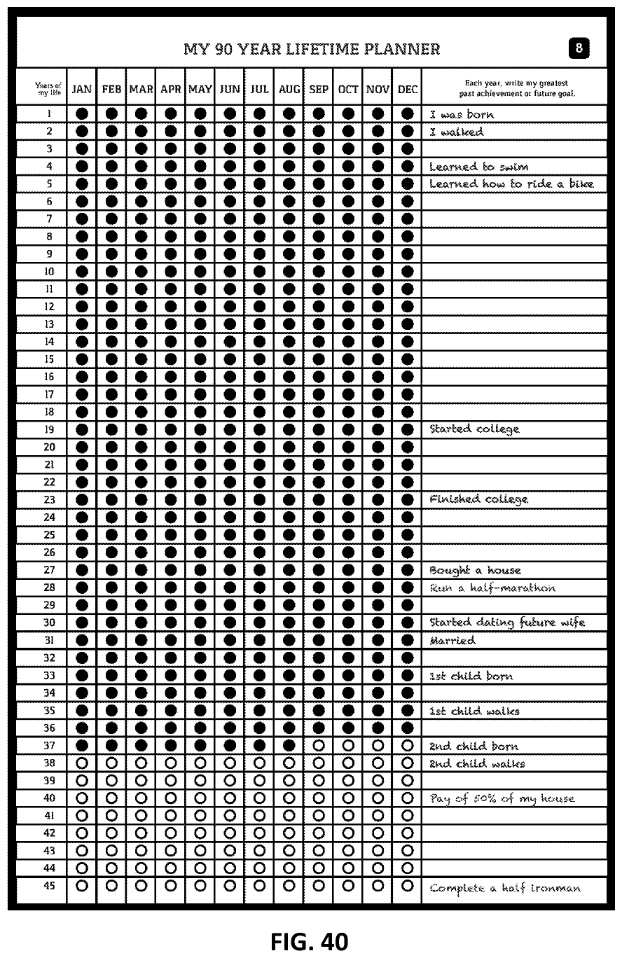

FIG. 40 is an example My 90 Year Lifetime Planner page that allows a user to look at 45 years at a time. FIG. 40 is an example page that is included in the My Lifetime Planner booklet to help a person see how to fill out this page. On each year the user can write their greatest past achievement or future goal. The months of each year are meant to be filled in one at a time so the user can see their life progressing and see a visual of upcoming goals. There are two of these pages in each book (one from years 1-45 and another from years 46-90). The user can use this page to break down a goal into high-level tasks completed in different years (or months), and this large overview helps an individual see if they are on track to hit a goal 10, 20, 30 or more years from now. This planner is not meant to replace the daily or monthly planner pages discussed previously. The My 90 Year Lifetime Planner pages help a person, in a two-page spread, map out their entire life.

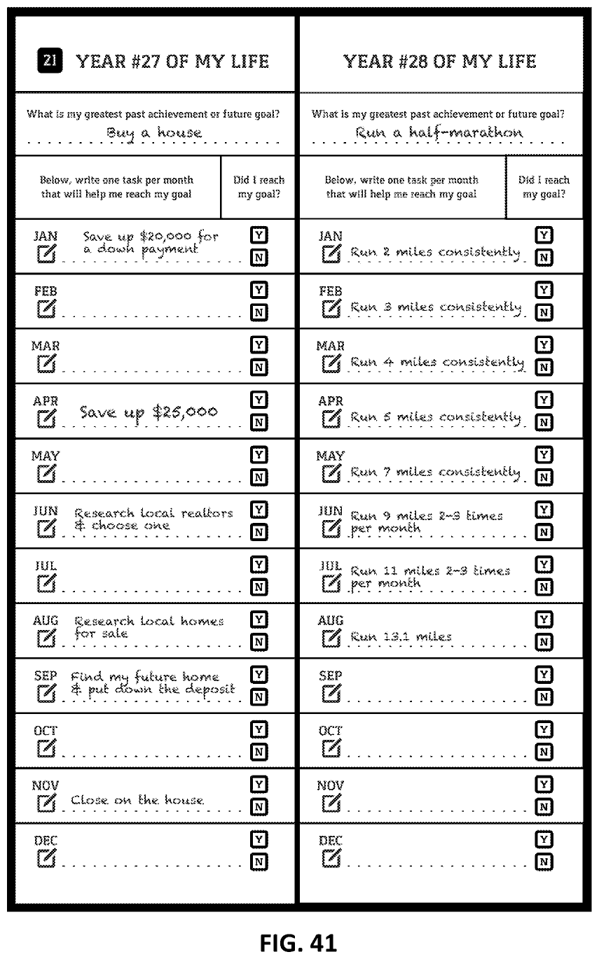

FIG. 41 is an example Year of My Life page that allows a user to look at two years at a time (and, since these pages are side to side, opening to one of these pages can help a user to see four years at a time by seeing two of these pages simultaneously). FIG. 41 is an example page that is included in the My Lifetime Planner booklet to help a person see how to fill out this page. The purpose of this page is to break down a top yearly goal into small actionable tasks or projects. For example in FIG. 41 one yearly goal the person has written down for Year 27 is to buy a house, and this is broken up into six different sub-tasks, to be done in six different months. The person can use the checkboxes or fill in the boxes to indicate yes or no (Y/N) regarding whether each sub-task was completed.

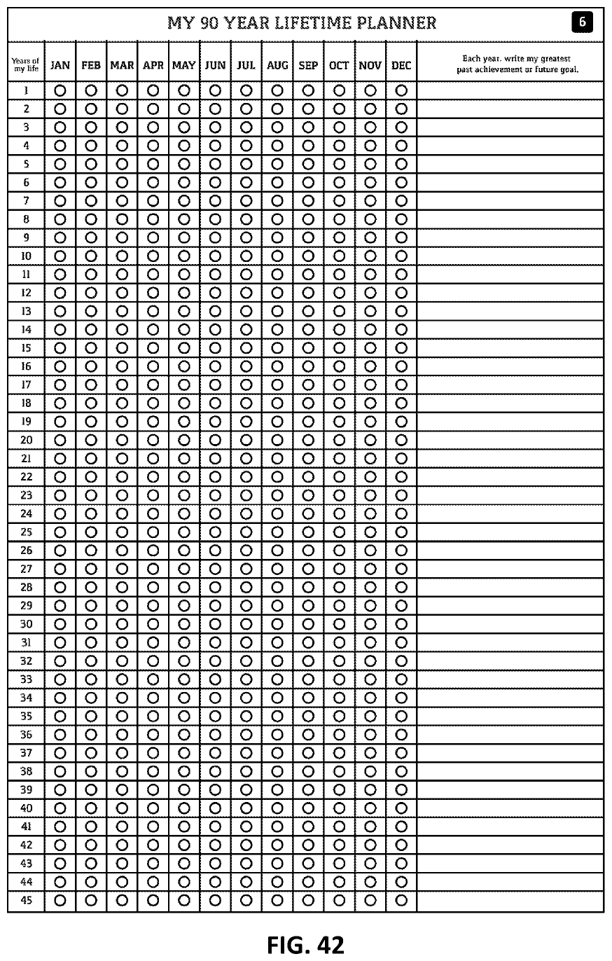

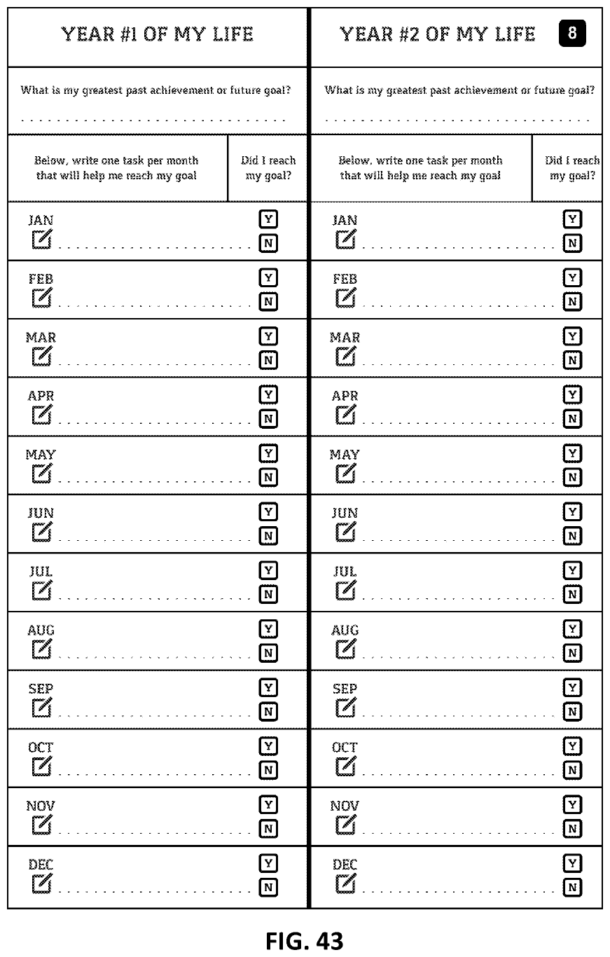

FIG. 42 is a blank My 90 Year Lifetime Planner page ready for the user to fill out, and again there are two of these to total up to 90 years (though there could be fewer or more, in other implementations, to add up to fewer than or more than 90 years). FIG. 43 is a blank Year of My Life page ready for the user to fill out, there are two years per page and again there are enough of these pages to total up to 90 years (though there could be fewer or more, in other implementations, to add up to fewer or more than 90 years). In Appendix E only a few are shown (up to Year #8 of My Life) for brevity, but in implementations there would be enough pages to go up to Year #90 of My Life, or further. The end of the My Lifetime Planner booklet also includes some blank pages for the user to write notes or the like, as they desire.

My Legacy Journal Booklet

The My Legacy Journal helps users create a lasting influence beyond their own mortal lives/existences. The movie SANDLOT includes the quote “Heroes get remembered but legends never die.” The My Legacy Journal booklet helps a person “never die” in two ways: by creating a journal for future descendants to read about the person's experiences and benefit from them; and by providing a service journal to help the person serve others so that the person's actions, life and existence live on through the lives of those the person has helped. As seen in Appendix F, the My Lifetime Planner booklet has imagery of the earth and moon (and a logo of the moon and stars) on the outsides of the first and last pages to remind the user that this booklet focuses on a perspective that includes a time after the user's mortal existence on earth (the first page in Appendix F represents the first and last pages of the booklet as it folds in the center to enclose all other pages of the booklet).

In viewing Appendices B-F it can be seen that the imagery of the booklets includes a theme of zooming out: Appendix B shows the ground and trees close up; Appendix C shows a zoomed-out perspective from which more trees can be seen; and Appendix D shows a zoomed-out perspective from which mountains, on which the trees are located, can be seen. Somewhat similarly, Appendix E shows clouds which can be thought of as zooming out further from the Appendix D imagery, and Appendix F shows the earth and moon which can be thought of as further zooming out from the Appendix E imagery. This zooming out helps the user to see the nature of the planners, that they focus on progressively larger perspectives and progressively longer-term goals/planning. Each booklet within the planner system enlarges the perspective with which we view our life. From the smallest (daily) perspective in the My Routine Tracker booklet and My Happiness Planner (Method and Calendar) booklets to the largest perspective in the My Lifetime Planner booklet and My Legacy Journal booklet.

The My Legacy Journal booklet helps a person leave a lasting legacy about things that really matter, such as how many people they helped in this world, how many people they loved and served, and how they chose to make the world a better place. The things of greatest value in our mortal life oven involve building relationships with those around us. The My Legacy Journal booklet is configured to help inspire the user to love others and make the world a better place. Acts of kindness and love will not only benefit the user's life today, but those acts can echo through the ages.

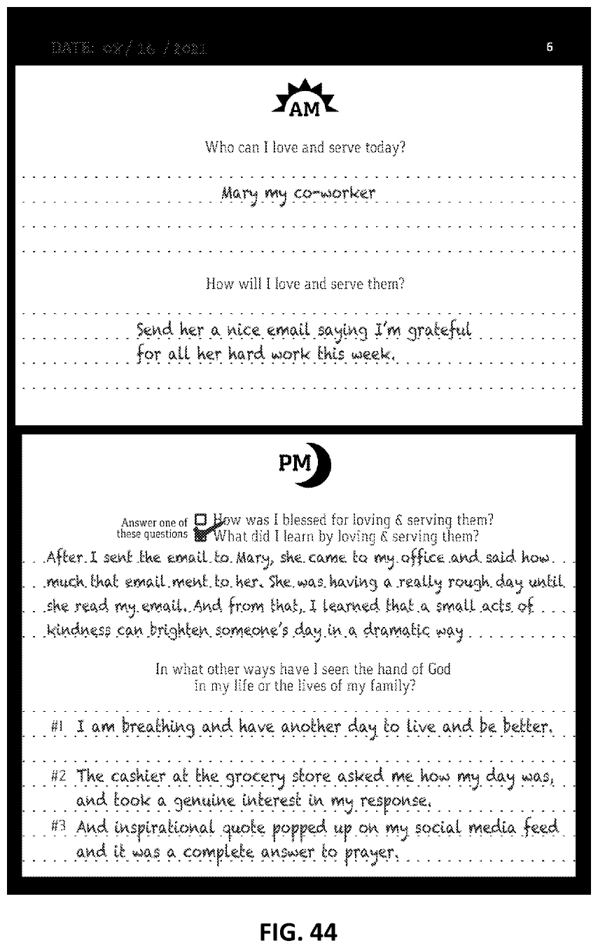

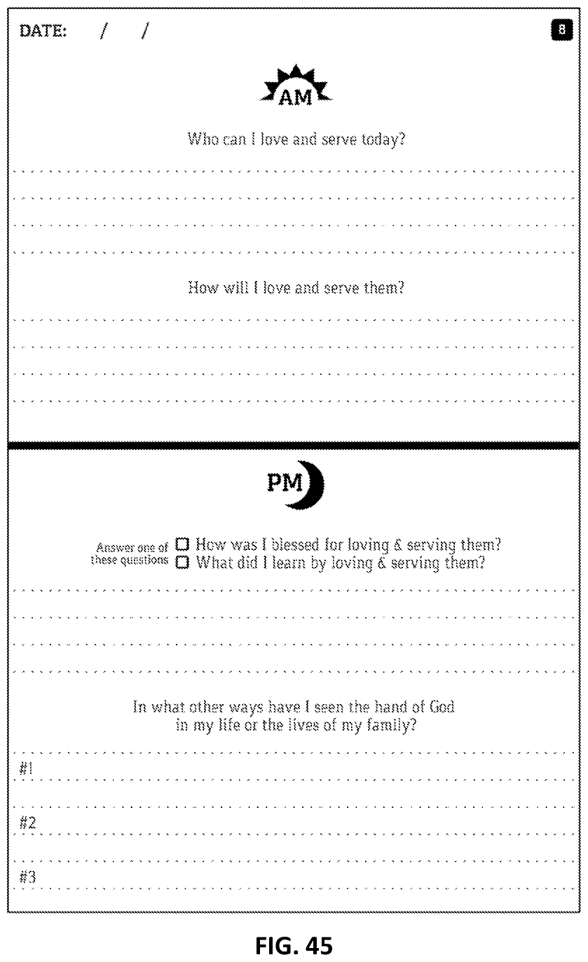

FIG. 44 shows an example journal page from the My Legacy Journal booklet. The example page is partially filled out to show the user how to fill this page out. The journal pages together help a user have a routine/progression of love and service. They also can be used to see more clearly the hand of God or of a higher power in one's life. FIG. 44 shows an AM space for the user to write down or journal who they can love and serve today and how they will love and serve them. There is also a PM space for the user to write down the answer to one of two questions, either: “How was I blessed for loving & serving them?” or “What did I learn by loving & serving them?” There are checkboxes for the user to indicate which question they are answering. There is also a space in the PM section for the user to write down other ways they saw the hand of God in their life or the lives of their family, with numbers for the user to write down three (or fewer or more) things. FIG. 45 is an unfilled or blank journal page from the My Legacy Journal booklet ready to be filled out by the user. This blank page also has a date section at the top for the user to fill out the date. These journal pages help individuals learn greater love and service for others in the world. Appendix F only shows a few of these unfilled pages, but in implementations there would be enough for a month or more of tracking/journaling. The end of the My Legacy Journal booklet also includes some blank pages for the user to write notes or the like, as they desire.

Notwithstanding the specific methods disclosed herein, users can use the booklets to do what they feel/think is best, and could make modifications to the methods disclosed herein as desired, using the booklets in ways not specifically discussed herein. There is novelty and utility in the booklets themselves, regardless of whether they are used for the specific methods disclosed herein or used for other methods.

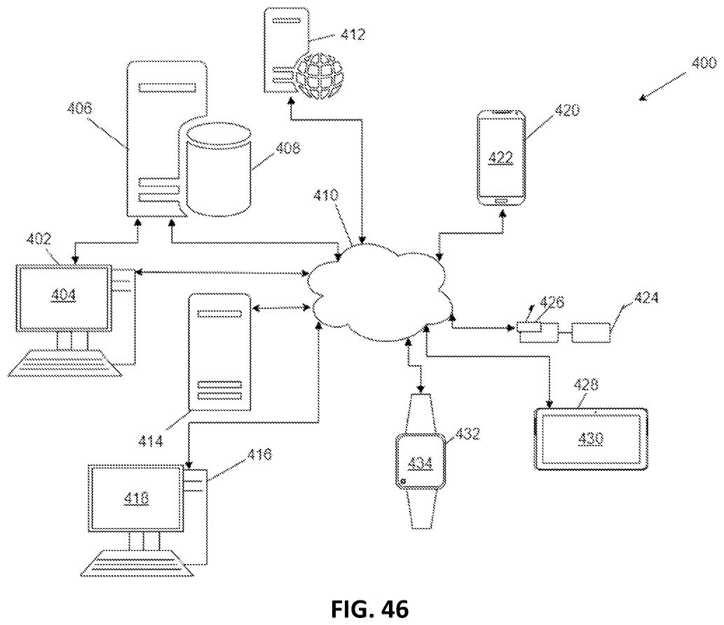

Although the planner system is described herein as a print planner system, in implementations any of the booklets and pages described herein could be implemented digitally, such as for the user to fill out on a computer, cell phone application, mobile device application and/or online. In such implementations, any of the pages shown in the drawings may be user interfaces with fillable fields for the user to fill out online or using a computer or cell phone app or mobile device app. For example, FIG. 46 representatively illustrates a diagram of a computing system (system) 400 which could be used to implement a digital version of the planner system. System 400 includes an administrator computing device 402 having a display 404, an administrator may use this device to set up and/or configure the computing system and its settings, such as setting up database or data store settings, configuring user interfaces identical to or modeled after the planner paged disclosed in the drawings and with fillable fields, and so forth. A database or data store 408 may be used to store data needed to facilitate the digital version (such as image files, user information, tables or data elements corresponding with the fields for each user, user profile information, etc.). Database server or data store server 406 is used to communicate with other elements of the system to write to the database or data store and to retrieve data therefrom. Devices 402 and 406 may be communicatively coupled either directly or through a telecommunications network 410 such as a local area network (LAN), the Internet, or so forth.

A web server 412 can allow administrators and/or end users to access elements of the system (such as the fillable user interfaces, the database or data store, etc.) through a web page using any device with access to the web page. An application server 414 can allow administrators and/or end users to access elements of the system (such as the fillable user interfaces, the database or data store, etc.) through a software application running on a desktop computer, laptop, tablet, visual headset, watch, mobile device or phone, etc.

A variety of end user devices can be used to access the fillable user interfaces, such as a desktop computing device 416 with a display 418, a laptop with a display, a mobile device or phone 420 with a display 422, a visual headset 424 (which could be glasses, a virtual reality headset, etc.—the drawing is drawn in simplified format) with a display 426, a tablet 428 with a display 430, a watch or smart watch 432 with a display 434, and so forth. Any other type of computing device with a display could be used. The display in each case may be used to show the user digital versions of the planner pages shown in the drawings and to allow the user to fill in fields in the respective locations of each page where something can be input by the user—the data then stored to the database or data store and/or erased and/or overwritten and/or retrieved as requested by the user through his/her computing device.

The planner cover is configured to substantially cover the booklets. As used herein, the phrase “substantially cover” in reference to the planner cover means that the planner cover covers the portions/areas/spaces of the booklets that a normal book binding covers relative to the pages of a book (i.e., at least the front of the first page, the back of the last page, and one side of each of the pages).

In some implementations the My Happiness Planner (Method and Calendar) booklets are only configured to receive and track tasks related to happiness (happiness tasks) related to the following five dimensions of happiness: spiritual, physical, intellectual, emotional, and social. Methods of use related to the planner system include using the planner system and/or any of its constituent booklets and/or pages in any of the ways described or inferred herein.

In some implementations the booklets include grayscale and/or lighter elements (of any color) that are functional. For example, referring to Appendix A (the My Routine Tracker booklet) the example pages (page 7 of the PDF—internal page numbers 8-9) when compared with the blank pages (page 8 of the PDF—internal page numbers 10-11, for example) reveal that the text “day,” “month” and “date” are meant to be written over, as shown in the example pages, to put the actual days, dates and month, and this is facilitated by the grayscale nature of the page which is lighter than the ink or pencil marking used to insert these elements. A similar functionality is shown in Appendix C (the My Happiness Planner Calendar booklet) page 5—internal page number 4—which shows checkboxes and checkmarks placed over the time elements 10 AM, 11 AM, etc. A similar functionality is also shown in Appendix D (the My Dream Big Planner booklet) pages 11-12—internal page numbers 17 and 18—which shows “Milepost 1” written over the text “write down the station you checked above.”

Grayscale and/or lighter elements (of any color) can also help to visually separate portions of pages, such as rows and/or columns, as seen in the example pages of Appendix A (page 7 of the PDF, internal page numbers 8-9), making it easier for the user to navigate rows and columns while filling out the fields. A similar functionality is shown in Appendix F wherein the AM and PM portions of the pages (for example pages 5-6—internal page numbers 5-6) are visually separated by the PM portion having a gray background and the AM portion having a white background—serving as a reminder that one portion is meant to be filled out in the morning (when it is lighter) and another in the evening (when it is darker). Other options are possible, and these are just examples. In implementations gray, grayscale and or lighter background elements (of any color) and/or text (also of any color) may be useful to provide instructions or commentary intended to be written over by the user's writing (including providing instructions in a location that is meant to be overwritten by the thing instructed to be put therein).

Not all pages of the appendices are drawn to scale—all pages of the PDFs are fitted to be the same size which makes the cover and last pages appear larger than they would actually be—in reality the cover and last pages of any given appendix/booklet would be the same size as, for example, internally-numbered page 1 of that same appendix/booklet. The cover and last page of each booklet could be printed on the same sheet to be folded to form both the front and back of the booklet. The booklets may have any page size, as desired. Any of the pages of the appendices/booklets can be duplicated (for instance so there are enough unfilled pages for an entire month of tracking, or multiple months, etc.—the appendices only show one or a few of each unfilled page for brevity).

In places where the phrase “one of A and B” is used herein, including in the claims, wherein A and B are elements, the phrase shall have the meaning “A and/or B.” This shall be extrapolated to as many elements as are recited in this manner, for example the phrase “one of A, B, and C” shall mean “A, B, and/or C,” and so forth. To further clarify, the phrase “one of A, B, and C” would include implementations having: A only; B only; C only; A and B but not C; A and C but not B; B and C but not A; and A and B and C.

In places where the description above refers to specific implementations of planner systems and related methods, one or more or many modifications may be made without departing from the spirit and scope thereof. Details of any specific implementation/embodiment described herein may, wherever possible, be applied to any other specific implementation/embodiment described herein. The appended claims are to encompass within their scope all such changes and modifications as are within the true spirit and scope of this disclosure.

Furthermore, in the claims, if a specific number of an element is intended, such will be explicitly recited, and in the absence of such explicit recitation no such limitation exists. For example, the claims may include phrases such as “at least one” and “one or more” to introduce claim elements. The use of such phrases should not be construed to imply that the introduction of any other claim element by the indefinite article “a” or “an” limits that claim to only one such element, and the same holds true for the use in the claims of definite articles.

Additionally, in places where a claim below uses the term “first” as applied to an element, this does not imply that the claim requires a second (or more) of that element—if the claim does not explicitly recite a “second” of that element, the claim does not require a “second” of that element. Furthermore, in some cases a claim may recite a “second” or “third” or “fourth” (or so on) of an element, and this does not necessarily imply that the claim requires a first (or so on) of that element—if the claim does not explicitly recite a “first” (or so on) of that element (or an element with the same name, such as “a widget” and “a second widget,” then the claim does not require a “first” (or so on) of that element.

Method steps disclosed anywhere herein, including in the claims, may be performed in any feasible/possible order. Recitation of method steps in any given order in the claims does not imply that the steps must be recited in that order—such claims are intended to cover the steps performed in any order except any orders which are technically impossible. However, in some implementations method steps may be performed in the order(s) in which the steps are presented herein, including any order(s) presented in the claims.

What is claimed is:

1. A planner system, comprising:
a planner cover; and
a plurality of pages coupled with the planner cover, the plurality of pages including:
one or more routine tracker pages configured for receiving and tracking a plurality of tasks related to a routine; and
one or more happiness planner pages configured for receiving and tracking a plurality of tasks related to improving happiness.

2. A planner system, comprising:
a planner cover;
one or more couplers; and
a plurality of booklets removably coupled with the planner cover using the one or more couplers;
wherein the planner cover is sized to substantially cover the plurality of booklets in a closed configuration;
wherein the plurality of booklets includes:
one or more routine tracker pages configured for receiving and tracking a plurality of daily tasks related to a routine; and
one or more happiness planner pages configured for receiving and tracking a plurality of daily tasks related to improving happiness.

3. The system of claim 2, wherein the one or more routine tracker pages includes a time field for each task related to the routine to indicate a time at which it will be carried out.

4. The system of claim 2, wherein the one or more routine tracker pages include a tally section to indicate a number of times per week that a specific task related to the routine was accomplished.

5. The system of claim 2, wherein the one or more routine tracker pages include a tally section to indicate a number of tasks related to the routine that were accomplished in a day.

6. The system of claim 5, wherein the one or more routine tracker pages includes a weekly tally section to indicate a number of tasks related to the routine that were accomplished in a week.

7. The system of claim 2, wherein the one or more happiness planner pages include a first section configured for receiving and tracking a spiritual task, a second section configured for receiving and tracking a physical task, a third section configured for receiving and tracking an intellectual task, a fourth section for receiving and tracking an emotional task, and a fifth section for receiving and tracking a social task.

8. The system of claim 7, wherein the one or more happiness planner pages include a plurality of example spiritual tasks, a plurality of example physical tasks, a plurality of example intellectual tasks, a plurality of example emotional tasks, and a plurality of example social tasks.

9. The system of claim 2, wherein the one or more happiness planner pages includes an affirmation section for receiving one or more user-input affirmations.

10. The system of claim 2, wherein the one or more happiness planner pages includes a gratitude section for a user to input one or more things the user is grateful for.

11. The system of claim 2, wherein the one or more happiness planner pages includes a daily happiness rating configured to receive a daily user-input happiness level on a scale.

12. The system of claim 2, wherein the one or more happiness planner pages include a tally section to indicate a number of times per week that a specific task related to improving happiness was accomplished.

13. The system of claim 2, wherein the one or more routine tracker pages include a tally section to indicate a number of tasks related to improving happiness that were accomplished in a day.

14. The system of claim 2, wherein the one or more routine tracker pages includes a weekly tally section to indicate a number of tasks related to improving happiness that were accomplished in a week.

15. The system of claim 2, wherein the one or more happiness planner pages includes a weekly happiness rating configured to receive a weekly user-input happiness level on a scale.

16. The system of claim 2, wherein the one or more happiness planner pages includes a section for receiving an indication of one or more things a user will continue doing to increase happiness.

17. The system of claim 2, wherein the one or more happiness planner pages includes a section for receiving an indication of one or more things a user will stop doing in order to increase happiness.

18. The system of claim 2, wherein the one or more happiness planner pages includes a section for receiving an indication of one or more things a user will start doing to increase happiness.

19. A planner system, comprising:
a planner cover;
a routine tracker booklet coupled within the planner cover and configured for receiving and tracking a plurality of daily tasks related to a routine (routine tasks); and
a happiness planner booklet coupled within the cover and configured for receiving and tracking a plurality of daily tasks related to improving happiness (happiness tasks);
wherein the routine tracker booklet includes a first tally section to indicate a number of times per week that a specific routine task was accomplished, a second tally section to indicate a number of routine tasks that were accomplished in a day, and a weekly tally section to indicate a number of routine tasks that were accomplished in a week; and
wherein the happiness planner booklet includes a first tally section to indicate a number of times per week that a specific happiness task was accomplished, a second tally section to indicate a number of happiness tasks that were accomplished in a day, and a weekly tally section to indicate a number of happiness tasks that were accomplished in a week.

20. The system of claim 19, wherein the happiness planner booklet includes a first section configured for receiving and tracking a spiritual task, a second section configured for receiving and tracking a physical task, a third section configured for receiving and tracking an intellectual task, a fourth section for receiving and tracking an emotional task, and a fifth section for receiving and tracking a social task.
